(19) United States
(12) Patent Application Publication
(10) Pub. No.: US 2015/0043391 A1
(43) Pub. Date: Feb. 12, 2015

(54) SYSTEMS AND METHODS FOR RECONFIGURATION SIGNALING

(71) Applicant: Sharp Laboratories of America, Inc., Camas, WA (US)

(72) Inventors: Zhanping Yin, Vancouver, WA (US); Shohei Yamada, Camas, WA (US)

(73) Assignee: Sharp Laboratories of America, Inc., Camas, WA (US)

(21) Appl. No.: 13/962,891

(22) Filed: Aug. 8, 2013

(51) Int. Cl. H04W 72/04; H04L 5/22; H04L 1/18

(52) U.S. Cl. CPC H04W 72/0406; H04L 1/1864; H04L 5/22
USPC 370/280

(57) ABSTRACT

A User Equipment (UE) for receiving time-division duplexing (TDD) uplink/downlink (UL/DL) configurations is described. The UE includes a processor and instructions stored in memory that is in electronic communication with the processor. The UE decodes UL/DL reconfiguration signaling on a physical downlink control channel (PDCCH) or enhanced physical downlink control channel (EPDCCH). The UE also determines if the UL/DL reconfiguration signaling is correctly decoded. The UE further sends feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

### TECHNICAL FIELD

The present disclosure relates generally to communication systems. More specifically, the present disclosure relates to systems and methods for reconfiguration signaling.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one configuration of one or more evolved Node Bs (eNBs) and one or more user equipments (UEs) in which systems and methods for reconfiguration signaling may be implemented;

FIG. 2 is a flow diagram illustrating one implementation of a method for reconfiguration signaling by a UE;

FIG. 3 is a flow diagram illustrating one implementation of a method for reconfiguration signaling by an eNB;

FIG. 4 is a diagram illustrating one example of a radio frame that may be used in accordance with the systems and methods disclosed herein;

FIG. 5 is a diagram illustrating time-division duplexing (TDD) uplink/downlink (UL/DL) configurations in accordance with the systems and methods described herein;

FIG. 6 is a diagram illustrating one example of reconfiguration signaling;

FIG. 7 is a flow diagram illustrating another implementation of a method for reconfiguration signaling by a UE;

FIG. 8 is a diagram illustrating another implementation of reconfiguration signaling;

FIG. 9 is a diagram illustrating yet another implementation of reconfiguration signaling;

FIG. 10 is a flow diagram illustrating yet another implementation of a method for reconfiguration signaling by a UE;

FIG. 11 is a flow diagram illustrating another implementation of a method for reconfiguration signaling by an eNB;

FIG. 12 illustrates various components that may be utilized in a UE;

FIG. 13 illustrates various components that may be utilized in an eNB;

FIG. 14 is a block diagram illustrating one configuration of a UE in which systems and methods for feedback reporting may be implemented; and

FIG. 15 is a block diagram illustrating one configuration of an eNB in which systems and methods for feedback reporting may be implemented.

### DETAILED DESCRIPTION

A User Equipment (UE) for receiving time-division duplexing (TDD) uplink/downlink (UL/DL) configurations is described. The UE includes a processor and instructions stored in memory that is in electronic communication with the processor. The UE decodes UL/DL reconfiguration signaling on a physical downlink control channel (PDCCH) or enhanced physical downlink control channel (EPDCCH). The UE also determines if the UL/DL reconfiguration signaling is correctly decoded. The UE further sends feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

The UL/DL reconfiguration signaling may be a PDCCH or an enhanced physical downlink control channel (EPDCCH) with a given DCI format. The feedback for the UL/DL reconfiguration signaling may be determined based on the uplink subframe. The feedback for the UL/DL reconfiguration signaling may include an acknowledgement or negative acknowledgement (ACK/NACK) message.

If an ACK is generated for the UL/DL reconfiguration signaling, the UE may generate the PDSCH HARQ-ACK information based on a DL subframe or a special subframe in a DL association set of a DL-reference UL/DL configuration. The DL subframe or the special subframe may be determined based on the UL/DL reconfiguration signaling.

If a NACK is generated for the UL/DL reconfiguration signaling, the UE may generate the PDSCH HARQ-ACK information based on a DL subframe or a special subframe in a DL association set of a DL-reference UL/DL configuration. The DL subframe or the special subframe may be determined based on the DL-reference UL/DL configuration. The DL subframe or the special subframe may be determined based on a UL/DL configuration determined by a SystemInformationBlock1 signal or a RadioResourceConfigCommon signal. The DL subframe may be a fixed DL subframe and the special subframe may be a fixed special subframe.

If the UL/DL reconfiguration signaling is correctly decoded, the UE may determine a DL subframe or a special subframe based on a UL/DL configuration indicated by the UL/DL reconfiguration signaling. If the UL/DL reconfiguration signaling is not correctly decoded, the UE may determine a DL subframe based on a fixed DL subframe or a special subframe based on a fixed special subframe. If the UL/DL reconfiguration signaling is not correctly decoded, the UE may determine a DL subframe or a special subframe based on a UL/DL configuration determined by a SystemInformationBlock1 signal or a RadioResourceConfigCommon signal. If the UL/DL reconfiguration signaling is not correctly decoded, the UE may determine a DL subframe or a special subframe based on a PDCCH downlink control information (DCI) format.

An evolved Node B (eNB) for sending TDD UL/DL configurations is also described. The eNB includes a processor and instructions stored in memory that is in electronic communication with the processor. The eNB sends UL/DL reconfiguration signaling on a PDCCH. The eNB also receives feedback for the UL/DL reconfiguration signaling and PDSCH HARQ-ACK information in an uplink subframe corresponding to the PDSCH HARQ-ACK information.

The UL/DL reconfiguration signaling may be a PDCCH or an EPDCCH with a given DCI format. The eNB may receive the feedback for the UL/DL reconfiguration signaling and the PDSCH HARQ-ACK information if the PDSCH HARQ-ACK information is expected in the uplink subframe. The feedback for the UL/DL reconfiguration signaling may include an ACK/NACK message.

The eNB may also decode the feedback for the UL/DL reconfiguration signaling and the PDSCH HARQ-ACK information assuming an ACK for the UL/DL reconfiguration signaling. The decoding may be based on a DL subframe or a special subframe in a DL association set of a DL-reference UL/DL configuration. The DL subframe or the special subframe may be determined based on the UL/DL reconfiguration signaling.

The eNB may also decode the feedback for the UL/DL reconfiguration signaling and the PDSCH HARQ-ACK information assuming a NACK for the UL/DL reconfiguration signaling. The decoding may be based on a DL subframe or a special subframe in a DL association set of a DL-reference UL/DL configuration. The DL subframe or the special subframe may be determined based on the DL-reference UL/DL configuration.

The eNB may also determine the correctness of the feedback for the UL/DL reconfiguration signaling based on a decoded output. The eNB may further determine the validity of the PDSCH HARQ-ACK information based on the decoded output.

A method for receiving TDD UL/DL configurations by a UE is also described. The method includes decoding UL/DL reconfiguration signaling on a PDCCH or EPDCCH. The method also includes determining if the UL/DL reconfiguration signaling is correctly decoded. The method further includes sending feedback for the UL/DL reconfiguration signaling and PDSCH HARQ-ACK information in an uplink subframe corresponding to the PDSCH HARQ-ACK information.

A method for sending TDD UL/DL configurations by an eNB is also described. The method includes sending UL/DL reconfiguration signaling on a PDCCH. The method also includes receiving feedback for the UL/DL reconfiguration signaling and PDSCH HARQ-ACK information in an uplink subframe corresponding to the PDSCH HARQ-ACK information.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10 and/or 11). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device (e.g., UE) and/or a base station (e.g., eNB).

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and/or receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed herein describe reconfiguration signaling associated with dynamic TDD UL/DL reconfiguration. In particular, the systems and methods disclosed herein describe feedback for UL/DL reconfiguration signaling. The systems and methods disclosed herein also describe fallback operations for UEs that support dynamic UL/DL reconfiguration if UL/DL reconfiguration signaling is missed or is not detected correctly. The feedback (e.g., acknowledgement) for UL/DL reconfiguration signaling may ensure the correct understanding between an eNB and a UE. It may also reduce the payload on the PUCCH, and may improve the reliability and performance of PDSCH HARQ-ACK.

It should be noted that dynamic UL/DL reconfiguration may also be referred to as enhanced interference mitigation with traffic adaptation (eIMTA). Therefore, a cell that supports dynamic UL/DL reconfiguration (e.g., a dynamic UL/DL reconfiguration cell) may be referred to as an eIMTA cell. As used herein, “the UE is configured with a dynamic UL/DL reconfiguration” may be referred to as “the UE is configured with a serving cell with dynamic subframe type conversion”, “the UE is configured with a DL-reference UL/DL configuration of the serving cell”, “the UE is configured with a UL-reference UL/DL configuration of the serving cell” or “the UE is configured with a DL-reference UL/DL configuration of the serving cell and a UL-reference UL/DL configuration of the serving cell”.

Enhanced interference mitigation with traffic adaptation (eIMTA) is a major topic for LTE TDD networks to enable more flexible use of spectrum using dynamic UL/DL allocation based on traffic load. Therefore, some subframes may be flexible and convertible (e.g., a flexible subframe) and may be used as either special, downlink or uplink as described below. With dynamic UL/DL reconfiguration, explicit PHY layer signaling may be used for UL/DL reconfiguration with a time scale of 10 milliseconds (ms) or less. The systems and methods described herein provide fallback solutions to improve the reliability and robustness of dynamic UL/DL reconfiguration.

A dynamic UL/DL reconfiguration cell is a TDD cell that supports dynamic UL/DL reconfiguration to adapt the traffic load on the cell. In LTE time-division duplexing (LTE TDD), the same frequency band may be used for both uplink and downlink signals. To achieve different DL and UL allocations (e.g., traffic ratios) in LTE TDD, seven uplink-downlink (UL/DL) configurations are given in 3GPP specifications (e.g., 3GPP TS 36.211). These allocations can allocate between 40% and 90% of subframes to DL signals.

According to current specifications (e.g., LTE Releases 8, 9, 10 and 11), a system information change procedure is used to change the UL/DL configuration. This procedure has long delay, and requires a cold system restart (e.g., all UEs in a system cannot transmit and receive for a certain period of time in order to disconnect the UL/DL associations of the old configuration and set up new associations). It should be noted that a subframe association may be referred to as a “UL/DL association,” which may include UL-to-DL subframe associations and DL-to-UL subframe associations. Examples of associations include association of a DL subframe (PDCCH) to UL power control in a UL subframe, association of a DL subframe physical DL control channel (PDCCH) to physical UL shared channel (PUSCH) allocation in a UL subframe, associations of acknowledgement and negative acknowledgement (ACK/NACK) feedback on UL subframe(s) for physical downlink shared channel (PDSCH) transmissions in DL subframe(s), association of acknowledgement and negative acknowledgement (ACK/NACK) feedback on a physical hybrid automatic repeat request (HARQ) indicator channel (PHICH) or physical downlink control channel (PDCCH) for physical UL shared channel (PUSCH) transmission(s) in UL subframe(s), etc.

Known physical (PHY) layer signaling may be extended to enable dynamic DL-to-UL conversion. For example, a special subframe type 2 may be used, which may be viewed as an extension of a current standard special subframe that is used for DL-to-UL transition. This special subframe type 2 can be used to provide UL transmissions while maintaining existing UL/DL associations. PHY layer signaling may also include using DCI 0/4 formats for PUSCH scheduling following the association timings of a UL-reference UL/DL configuration, and using DCI formats 1/2 and extensions for PDSCH scheduling, etc.

As used herein, a “Release 12 UE” may be a UE that may operate in accordance with anticipated 3GPP Release 12 specifications and possibly subsequent specifications. A Release 12 UE may be a UE that supports dynamic UL/DL reconfiguration. Additionally, as used herein, a “legacy UE” may be a UE that may operate in accordance with earlier (e.g., LTE Releases 8, 9, 10, 11) specifications.

Dynamic UL/DL reconfiguration may be applied for both DL-to-UL and UL-to-DL reconfiguration or switching. Dynamic UL/DL reconfiguration allows applying one configuration for PDSCH hybrid automatic repeat request acknowledgement (HARQ-ACK) timing and applying another configuration for PUSCH scheduling and PUSCH HARQ-ACK timing. UEs that support dynamic UL/DL reconfiguration may follow these timings based on the corresponding reference UL/DL configurations in an allowed UL/DL reconfiguration range (e.g., switching region). Legacy UEs may follow the existing associations without any change or knowledge of the dynamic UL/DL reconfiguration. However, the eNB may restrict the legacy UEs in some subframes to maintain backward compatible timing.

In known LTE TDD systems, the UL and DL allocation is chosen from seven defined UL/DL configurations, and is synchronized system-wide. Currently, UL/DL allocation reconfiguration in a cell may be very costly because all transmissions have to be stopped to adjust the UL/DL associations. A change in one cell may cause or accompany a sequence of changes at neighbor cells (and their neighbor cells, etc.) to match UL/DL configuration synchronization at neighbor cells (and their neighbor cells, etc.). Furthermore, current UL/DL allocation reconfiguration requires a system information change. Thus, it has long delay and is not adaptive to instantaneous or short-term changes in traffic load.

The systems and methods disclosed herein provide approaches for applying PDSCH HARQ-ACK timings for UEs that may operate in accordance with anticipated Release 12 specifications (and beyond) based on different DL-reference UL/DL configurations. For legacy UEs, impacts and restrictions of allowing legacy UEs to operate without any modifications to existing timings are also analyzed herein.

Based on an allowed UL/DL reconfiguration range, for example, the PDSCH HARQ-ACK timing may be configured differently for UEs that support dynamic UL/DL reconfiguration than for legacy UEs. A legacy UE should assume no HARQ-ACK timing change. However, the eNB may schedule legacy UEs to avoid potential conflicts.

For UEs that support and are configured with dynamic UL/DL reconfiguration cells, the PDSCH HARQ-ACK timing of a dynamic UL/DL reconfiguration cell may be based on one reference UL/DL configuration, while PUSCH scheduling and PUSCH HARQ-ACK timing of a dynamic UL/DL reconfiguration cell may be based on another reference UL/DL configuration. For example, the PDSCH HARQ-ACK configuration may follow a first reference UL/DL configuration with a number (e.g., minimum number) of UL subframes in the allowed UL/DL reconfiguration range. The first reference UL/DL configuration may or may not be the same as a default UL/DL configuration.

The PUSCH scheduling and PUSCH HARQ-ACK timing of a dynamic UL/DL reconfiguration cell may follow a second reference UL/DL configuration with a number (e.g., maximum number) of UL subframes in the allowed UL/DL reconfiguration range. The second reference UL/DL configuration may or may not be the same as a default UL/DL configuration. For subframes with allowed UL/DL switching (e.g., subframes in one or more convertible regions), systems and methods are provided herein for providing PDSCH HARQ-ACK timing when dynamic UL/DL reconfiguration is configured.

In current specifications (e.g., LTE Releases 8, 9, 10 and 11), a system information change procedure may be used to change the UL/DL configuration. This procedure requires multiple broadcast channel intervals and thus has a long delay and cannot adapt to an instantaneous traffic load change. Examples of UL/DL associations (in LTE-TDD, for instance) include the association of a PDCCH for UL power control of a UL subframe, association of a PDCCH for physical uplink shared channel (PUSCH) allocation in a UL subframe, associations of ACK/NACK feedback of DL transmission on UL subframe(s), ACK/NACK feedback of UL transmission on PHICH or PDCCH, etc. Due to different UL/DL associations, all transmitters may have to turn off the transmissions altogether to disconnect the UL/DL associations of the old configuration and to set up the new associations.

This may cause a huge loss of system capacity (e.g., offered load on uplink or downlink) and user traffic interruption. Thus, the reconfiguration of UL and DL allocation may also be very costly. Furthermore, a change in one cell may force adjacent cells to change their UL/DL configurations. Thus, a “ripple” effect may occur. With high traffic load fluctuation, frequent UL/DL reconfiguration may cause serious network problems.

When the network aggregated traffic load-to-capacity ratio is low, a UL/DL configuration is acceptable if the UL traffic and DL traffic load can be supported by the allocated UL subframes and DL subframes, respectively. In this case, the actual UL/DL traffic ratio may be the same or different from the UL/DL allocation. On the other hand, if the total traffic load-to-capacity ratio is high, a better matching UL/DL ratio may be configured.

A reconfiguration may be needed in several cases. For example, a reconfiguration may be needed if the allocated UL resource cannot support the UL traffic load. In another example, reconfiguration may be needed if the allocated DL resource cannot support the DL traffic load. Furthermore, a reconfiguration may be used to adapt to a traffic load with a better matching UL/DL allocation. For instance, a reconfiguration may be needed if a current UL/DL configuration does not match the UL-to-DL traffic ratio.

In order to better adapt to traffic conditions, dynamic UL/DL reconfiguration procedures may be supported aside from the system information change. Dynamic UL/DL reconfiguration may maintain backward compatibility (for legacy UEs, for example) and provide more flexibility (for UEs operating in accordance with Release 12 specifications and beyond, for example) with fast subframe modifications based on real-time traffic changes. Furthermore, different UL/DL configurations in neighboring cells may be supported (in Release 11, for example) in a temporary or persistent manner with co-channel interference mitigation techniques. The different UL/DL configurations may be caused by different initial network configurations and/or by dynamic UL/DL reconfiguration changes with traffic adaptation.

In Releases 8, 9, 10 and 11, the TDD UL/DL associations on PDSCH HARQ-ACK, PUSCH scheduling and PUSCH HARQ-ACK are defined by the TDD UL/DL configuration. All legacy UEs in the network follow the same PDSCH HARQ-ACK report associations defined by the given TDD UL/DL configuration. Similarly, all legacy UEs in the network follow the same PUSCH scheduling and PUSCH HARQ-ACK report associations defined by the given TDD UL/DL configuration.

However, dynamic UL/DL reconfiguration provides an approach that may separate PDSCH and PUSCH timing associations based on different reference UL/DL configurations. For example, a network (e.g., one or more UEs and one or more eNBs) may be configured to allow dynamic UL/DL reconfiguration based on traffic adaptation (aside from the default UL/DL configuration as in Releases 8, 9, 10 and 11). For instance, a UE that is configured to allow dynamic UL/DL reconfiguration may utilize one reference UL/DL configuration for PDSCH HARQ-ACK association (e.g., a DL-reference UL/DL configuration) and another reference UL/DL configuration for PUSCH scheduling and PUSCH HARQ-ACK association (e.g., an UL-reference UL/DL configuration), while the UE has knowledge of a default UL/DL configuration (e.g., a first UL/DL configuration). Therefore, because a dynamic UL/DL reconfiguration cell may dynamically change its TDD UL/DL configuration, the DL-reference UL/DL configuration should be specified.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Thus, the following more detailed description of several implementations, as represented in the figures, is not intended to limit scope, as claimed, but is merely representative of the systems and methods.

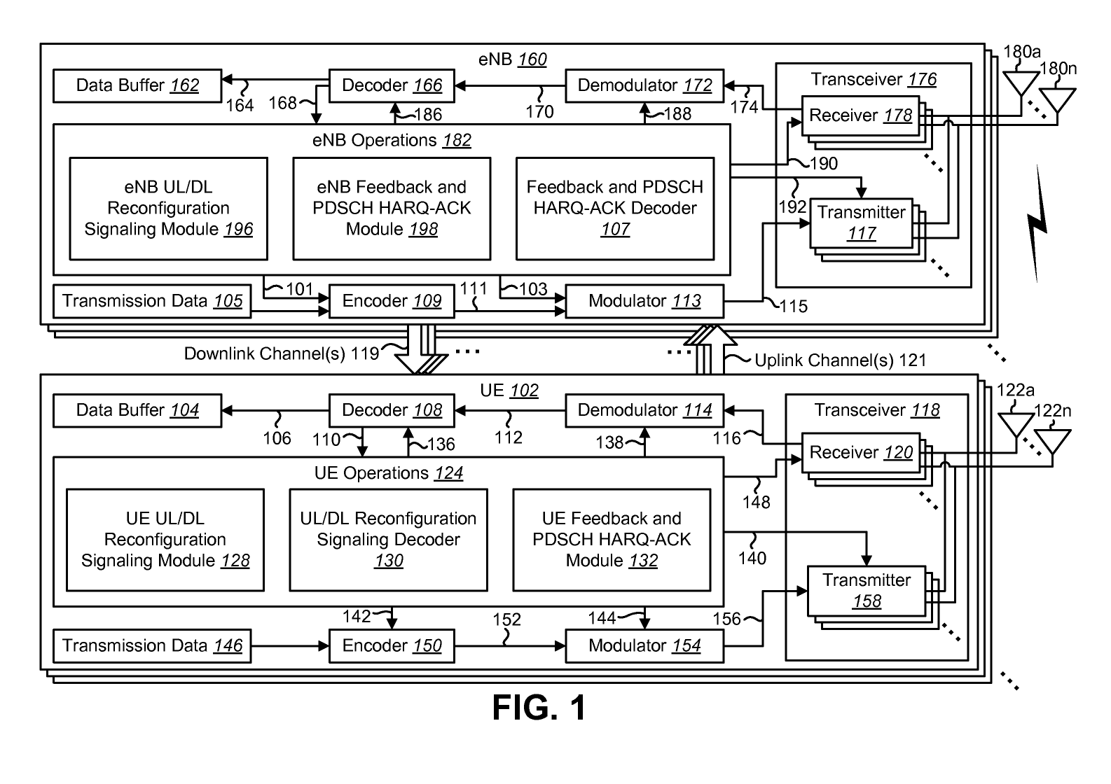

FIG. 1 is a block diagram illustrating one configuration of one or more eNBs 160 and one or more UEs 102 in which systems and methods for reconfiguration signaling may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a PUCCH and a PUSCH, etc. The one or more eNBs 160 may also transmit information or data to the one or more UEs 102 using one or more downlink channels 119, for instance. Examples of downlink channels 119 include a PDCCH, an EPDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include one or more of a UE UL/DL reconfiguration signaling module 128, a UL/DL reconfiguration signaling decoder 130 and a UE feedback and PDSCH HARQ-ACK module 132.

The UE UL/DL reconfiguration signaling module 128 may receive a UL/DL reconfiguration signaling to configure the UE 102 with a serving cell. The UE UL/DL reconfiguration signaling module 128 may receive the UL/DL reconfiguration signaling from an eNB 160. The signaling may indicate a UL/DL configuration for a serving cell to which the UE 102 may reconfigure in the next radio frame. In one implementation, the UE UL/DL reconfiguration signaling module 128 may receive a PDCCH or an EPDCCH in which the UL/DL reconfiguration signaling is encoded.

The UL/DL reconfiguration signaling decoder 130 may decode the UL/DL reconfiguration signaling in the PDCCH or EPDCCH. For example, the UL/DL reconfiguration signaling decoder 130 may decode the downlink control information (DCI) of the PDCCH or the EPDCCH in one or more subframes to detect the UL/DL reconfiguration signaling. In the case of multiple subframes, explicit UL/DL reconfiguration signaling may be determined based on multiple PDCCHs or EPDCCHs in multiple subframes.

The UL/DL reconfiguration signaling decoder 130 may determine if the UL/DL reconfiguration signaling is correctly decoded. For example, the UL/DL reconfiguration signaling decoder 130 may determine whether an expected UL/DL reconfiguration signaling in the correct subframe was received. The UL/DL reconfiguration signaling decoder 130 may also determine whether the UL/DL reconfiguration signaling is correctly decoded based on a cyclic redundancy check (CRC) or other error detection procedure.

The UE feedback and PDSCH HARQ-ACK module 132 may send feedback for the UL/DL reconfiguration signaling and PDSCH HARQ-ACK information in an uplink subframe corresponding to the PDSCH HARQ-ACK information. The PDSCH HARQ-ACK information may be scheduled to be sent in a given UL subframe. The UL/DL reconfiguration signaling may be acknowledged together with PDSCH HARQ-ACK reporting if the UE 102 is configured to acknowledge the UL/DL reconfiguration signaling. The feedback for the UL/DL reconfiguration signaling may be added to the PDSCH HARQ-ACK information of the dynamic UL/DL reconfiguration cell.

The feedback for the UL/DL reconfiguration signaling may be an acknowledgement or negative acknowledgement (ACK/NACK) message. An ACK/NACK bit may indicate an ACK if the UL/DL reconfiguration signaling is received correctly or a NACK if the UL/DL reconfiguration signaling is not received correctly.

The UE feedback and PDSCH HARQ-ACK module 132 may determine the feedback for the UL/DL reconfiguration signaling based on the uplink subframe. For example, the ACK/NACK message for the UL/DL reconfiguration signaling may depend on a DL association set corresponding to the given uplink subframe. If the DL association set includes only subframes from one radio frame, the ACK/NACK feedback for the UL/DL reconfiguration signaling may indicate the correct detection of UL/DL reconfiguration signaling for that radio frame. In another example, if the DL association set includes subframes from different radio frames, the ACK/NACK feedback for the UL/DL reconfiguration signaling may indicate the correct detection of the UL/DL reconfiguration signaling in each radio frame.

If an ACK is generated for the UL/DL reconfiguration signaling (e.g., if the UL/DL reconfiguration signaling is correctly decoded), the UE feedback and PDSCH HARQ-ACK module 132 may generate the PDSCH HARQ-ACK information based on a DL subframe or a special subframe in a DL association set of a DL-reference UL/DL configuration. In this case, the DL subframe or the special subframe may be determined based on the UL/DL reconfiguration signaling. In other words, if the UL/DL reconfiguration signaling is correctly received, the number of PDSCH HARQ-ACK bits may be determined based on the actual number of DL subframe allocations of the UL/DL configuration indicated by the UL/DL reconfiguration signaling.

If a NACK is generated for the UL/DL reconfiguration signaling (e.g., if the UL/DL reconfiguration signaling is not correctly decoded), the UE feedback and PDSCH HARQ-ACK module 132 may follow fallback behavior. In this case, the UE feedback and PDSCH HARQ-ACK module 132 may generate the PDSCH HARQ-ACK information based on one or more DL subframes and/or one or more special subframes in a DL association set of a DL-reference UL/DL configuration. However, the UE feedback and PDSCH HARQ-ACK module 132 may determine a DL subframe or a special subframe using different approaches. In one approach, the UE feedback and PDSCH HARQ-ACK module 132 may determine a DL subframe based on a fixed DL subframe and may determine a special subframe based on a fixed special subframe.

In another approach, the UE feedback and PDSCH HARQ-ACK module 132 may determine the DL subframe or the special subframe based on a specified (e.g., default) UL/DL configuration. In one implementation, the UE feedback and PDSCH HARQ-ACK module 132 may determine the DL subframe or the special subframe based on a UL/DL configuration indicated by a SystemInformationBlock1 signal or a RadioResourceConfigCommon signal in the case of a PCell and a RadioResourceConfigCommonSCell-r10 signal in the case of a SCell. In another implementation, the UE feedback and PDSCH HARQ-ACK module 132 may determine the DL subframe or the special subframe based on the UL-reference UL/DL configuration of the dynamic UL/DL reconfiguration cell.

In yet another approach, the UE feedback and PDSCH HARQ-ACK module 132 may determine the DL subframe or the special subframe based on the DL-reference UL/DL configuration. The actual use of the subframes may be determined implicitly by PDCCH or EPDCCH DCI formats.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include the PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. In some configurations, this may be based on the UL/DL reconfiguration signaling. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include one or more of an eNB UL/DL reconfiguration signaling module 196, an eNB feedback and PDSCH HARQ-ACK module 198 and a feedback and PDSCH HARQ-ACK decoder 107.

The eNB UL/DL reconfiguration signaling module 196 may send UL/DL reconfiguration signaling to configure a UE 102 with a serving cell. The signaling may indicate a UL/DL configuration for a serving cell to which the UE 102 may reconfigure in the next radio frame. In one implementation, the eNB UL/DL reconfiguration signaling module 196 may send a PDCCH or an EPDCCH transmission in which the UL/DL reconfiguration signaling is encoded.

The eNB feedback and PDSCH HARQ-ACK module 198 may receive feedback for the UL/DL reconfiguration signaling and PDSCH HARQ-ACK information in an uplink subframe corresponding to the PDSCH HARQ-ACK information. The PDSCH HARQ-ACK information may be scheduled to be received in a given UL subframe. The feedback for the UL/DL reconfiguration signaling may be added (by the UE 102) to the PDSCH HARQ-ACK information. Therefore, the eNB feedback and PDSCH HARQ-ACK module 198 may receive the feedback for the UL/DL reconfiguration signaling and the PDSCH HARQ-ACK information if the PDSCH HARQ-ACK information is expected in the UL subframe.

The feedback and PDSCH HARQ-ACK decoder 107 may perform blind decoding to obtain the ACK/NACK feedback for the UL/DL reconfiguration signaling and the PDSCH HARQ-ACK information. In one case, the feedback and PDSCH HARQ-ACK decoder 107 may decode the feedback for the UL/DL reconfiguration signaling and the PDSCH HARQ-ACK information assuming an ACK for the UL/DL reconfiguration signaling. In this case, the DL subframe or the special subframe is determined based on the UL/DL reconfiguration signaling. In other words, if the UL/DL reconfiguration signaling was correctly received by the UE 102, the number of PDSCH HARQ-ACK bits may be determined based on the actual number of DL subframe allocations of the UL/DL configuration indicated by the UL/DL reconfiguration signaling.

The feedback and PDSCH HARQ-ACK decoder 107 may determine the correctness of the feedback for the UL/DL reconfiguration signaling based on the decoded output. If the feedback and PDSCH HARQ-ACK decoder 107 determines that the decoded ACK/NACK feedback for the UL/DL reconfiguration signaling is an ACK, the feedback and PDSCH HARQ-ACK decoder 107 may accept the PDSCH HARQ-ACK information.

If the feedback and PDSCH HARQ-ACK decoder 107 determines that the decoded ACK/NACK feedback of the UL/DL reconfiguration signaling is not an ACK, the feedback and PDSCH HARQ-ACK decoder 107 may decode the feedback for the UL/DL reconfiguration signaling and the PDSCH HARQ-ACK information assuming a NACK for the UL/DL reconfiguration signaling. As with the decoding based on the ACK assumption, this decoding is based on a DL subframe or a special subframe in a DL association set of a DL-reference UL/DL configuration. However, in this case, the DL subframe or the special subframe is determined based on the DL-reference UL/DL configuration. In other words, the number of PDSCH HARQ-ACK bits may be determined based on the DL subframe allocations of the DL-reference UL/DL configuration.

As with the blind decoding based on the ACK assumption, the feedback and PDSCH HARQ-ACK decoder 107 may determine the correctness of the feedback for the UL/DL reconfiguration signaling and the validity of the PDSCH HARQ-ACK information based on the decoded output. For example, if the feedback and PDSCH HARQ-ACK decoder 107 determines that the decoded ACK/NACK feedback for the UL/DL reconfiguration signaling is a NACK, the feedback and PDSCH HARQ-ACK decoder 107 may accept the PDSCH HARQ-ACK information.

The eNB operations module 182 may provide information 190 to the one or more receivers 178. For example, the eNB operations module 182 may inform the receiver(s) 178 when or when not to receive transmissions from the UE(s) 102.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101.

The encoder 109 may encode transmission data 105 and/or other information 101 provided by the eNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. In some implementations, this may be based on the UL/DL reconfiguration signaling. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated (LSI) circuit or integrated circuit, etc.

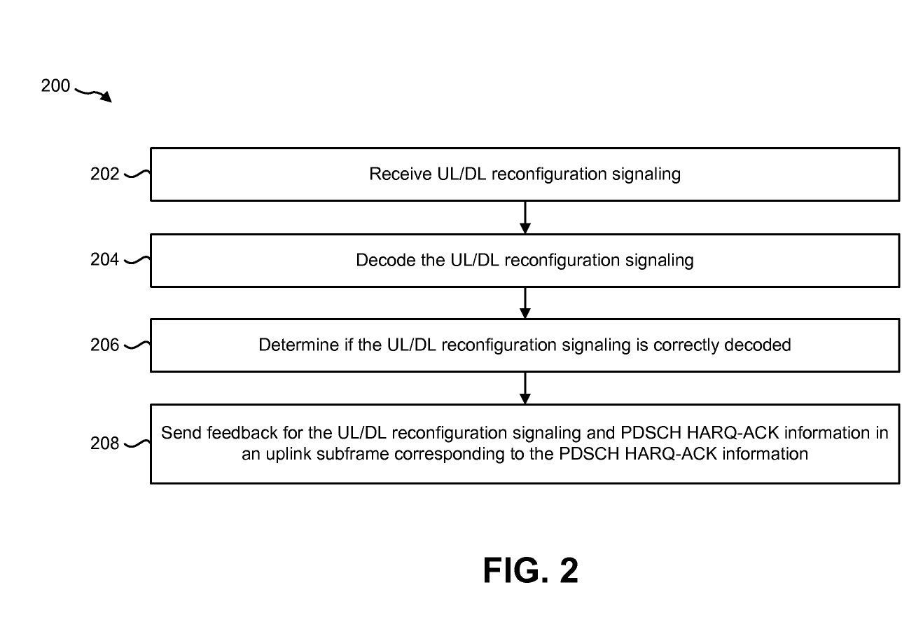

FIG. 2 is a flow diagram illustrating one implementation of a method 200 for reconfiguration signaling by a UE 102. The UE 102 may be configured with dynamic UL/DL reconfiguration (e.g., eIMTA support). The UE 102 may receive 202 UL/DL reconfiguration signaling to configure the UE 102 with a serving cell. As described above, a serving cell may be a cell of which the UE 102 is aware and is allowed by an eNB 160 to transmit or receive information. The UE 102 may receive 202 the UL/DL reconfiguration signaling from an eNB 160. The signaling may indicate a UL/DL configuration for a serving cell to which the UE 102 may reconfigure in the next radio frame. The UE 102 may receive 202 a PDCCH or an EPDCCH in which the UL/DL reconfiguration signaling is encoded.

In one implementation, the UL/DL reconfiguration signaling may be a PDCCH or an EPDCCH with a given DCI format. For example, a DCI may transport information for one Radio Network Temporary Identifier (RNTI). The RNTI may be implicitly encoded in a 16 bit Cyclic Redundancy Check (CRC). Error detection may be provided on DCI transmissions through a CRC. The entire payload may be used to calculate the CRC parity bits. After CRC attachment, the CRC parity bits may be scrambled with the corresponding RNTI. In some implementations, RNTI for UL/DL reconfiguration may be signaled from the eNB 160 to the UE 102. A 3 bit TDD UL/DL configuration field and information for a UE 102 or a group of UEs 102 may be provided in the DCI payload. To align with a size of other DCI format (e.g., DCI format 0/1A), padding bits may be included in the payload. Other 3 bit TDD UL/DL configuration fields may be assigned to other UEs 102 or other group of UEs 102. If the UE 102 could not detect the CRC scrambled with the corresponding RNTI in a DCI decoding process, UE 102 may consider that the DCI is not detected or is not correctly decoded. If the contents of DCI are not aligned with expected values, UE 102 may also consider that the DCI is not correctly decoded.

The UE 102 may decode 204 the UL/DL reconfiguration signaling on the PDCCH or EPDCCH. For example, the UE 102 may decode 204 the downlink control information (DCI) of the PDCCH or the EPDCCH in one or more subframes to detect the UL/DL reconfiguration signaling. In the case of multiple subframes, explicit UL/DL reconfiguration signaling may be determined based on multiple PDCCHs or EPDCCHs in multiple subframes.

The UE 102 may determine 206 if the UL/DL reconfiguration signaling is correctly decoded. For example, the UE 102 may determine whether it received an expected UL/DL reconfiguration signaling in the correct subframe. The UE 102 may also determine whether the UL/DL reconfiguration signaling is decoded correctly based on a cyclic redundancy check (CRC) or other error detection procedure. In some implementations, the subframes in which the UL/DL reconfiguration signaling is located may be predetermined. The UE 102 may try to decode the UL/DL reconfiguration signaling in those subframes. If the UE 102 could not find any UL/DL reconfiguration signaling which passed CRC, the UE 102 may determine that it is not correctly decoded. Furthermore, if the repetition of the UL/DL reconfiguration signaling is applied, the signals in a set of subframes may be combined and whether the UL/DL reconfiguration signaling is correctly decoded or not may be determined from for the combined signal.

The UE 102 may send 208 feedback for the UL/DL reconfiguration signaling and PDSCH HARQ-ACK information in an uplink subframe corresponding to the PDSCH HARQ-ACK information. The PDSCH HARQ-ACK information may be scheduled to be sent in a given UL subframe. The UL/DL reconfiguration signaling may be acknowledged together with PDSCH HARQ-ACK reporting if the UE 102 is configured to acknowledge the UL/DL reconfiguration signaling. The feedback for the UL/DL reconfiguration signaling may be added to the PDSCH HARQ-ACK information of the dynamic UL/DL reconfiguration cell.

In one implementation, the feedback for the UL/DL reconfiguration signaling comprises an acknowledgement or negative acknowledgement (ACK/NACK) message. One bit (e.g., an ACK/NACK bit) may be added to the PDSCH HARQ-ACK bits in PUCCH or PUSCH reporting. The ACK/NACK bit may indicate an ACK if the UL/DL reconfiguration signaling is received correctly or a NACK if the UL/DL reconfiguration signaling is not received correctly.

The feedback for the UL/DL reconfiguration signaling may be determined based on the uplink subframe. The ACK/NACK message for the UL/DL reconfiguration signaling may depend on a DL association set (or window) corresponding to the given uplink subframe. For example, if the DL association set includes only subframes from one radio frame, the ACK/NACK feedback for the UL/DL reconfiguration signaling may indicate the correct detection of UL/DL reconfiguration signaling for that radio frame. In another example, if the DL association set includes subframes from different radio frames, the ACK/NACK feedback for the UL/DL reconfiguration signaling may indicate the correct detection of the UL/DL reconfiguration signaling in concerned radio frames. The concerned set of the UL/DL reconfiguration signaling may depend on the DL association set corresponding to the given uplink subframe. For example, if the DL-reference UL/DL configuration is 5, the number of radio frames for the set of the UL/DL reconfiguration signaling concerned to the given uplink subframe may be two.

If an ACK is generated for the UL/DL reconfiguration signaling (e.g., if the UL/DL reconfiguration signaling is correctly decoded), the UE 102 may generate the PDSCH HARQ-ACK information based on a DL subframe or a special subframe in a DL association set of a DL-reference UL/DL configuration. However, in this case, the DL subframe or the special subframe may be determined based on the UL/DL reconfiguration signaling. In other words, if the UL/DL reconfiguration signaling is correctly received, the number of PDSCH HARQ-ACK bits may be determined based on the actual number of DL subframe allocations of the UL/DL configuration indicated by the UL/DL reconfiguration signaling.

If a NACK is generated for the UL/DL reconfiguration signaling (e.g., if the UL/DL reconfiguration signaling is not correctly decoded), the UE 102 may follow fallback behavior. In this case, the UE 102 may generate the PDSCH HARQ-ACK information based on one or more DL subframes and/or one or more special subframes in a DL association set of a DL-reference UL/DL configuration. However, the UE 102 may determine a DL subframe or a special subframe using different approaches. In one approach, the UE 102 may determine a DL subframe based on a fixed DL subframe or may determine a special subframe based on a fixed special subframe.

In another approach, the UE 102 may determine the DL subframe or the special subframe based on a specified (e.g., default) UL/DL configuration. In one implementation, the UE 102 may determine the DL subframe or the special subframe based on a UL/DL configuration indicated by a SystemInformationBlock1 signal or a RadioResourceConfigCommon signal in the case of a PCell and a RadioResourceConfigCommonSCell-r10 signal in the case of a SCell. In another implementation, the UE 102 may determine the DL subframe or the special subframe based on the UL-reference UL/DL configuration of the dynamic UL/DL reconfiguration cell.

In yet another approach, the UE 102 may determine the DL subframe or the special subframe based on the DL-reference UL/DL configuration. The actual use of the subframes may be determined implicitly by PDCCH or EPDCCH DCI formats.

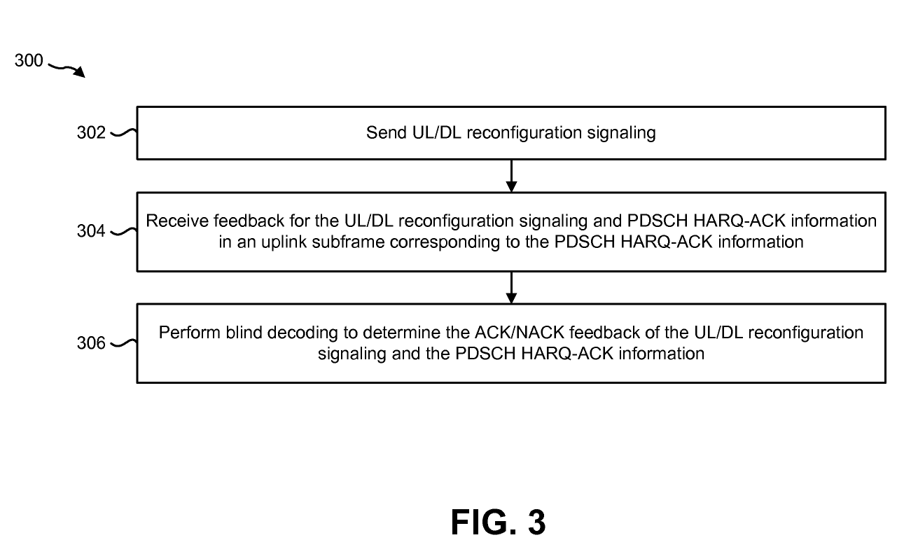

FIG. 3 is a flow diagram illustrating one implementation of a method 300 for reconfiguration signaling by an eNB 160. The eNB 160 may be configured with dynamic UL/DL reconfiguration (e.g., eIMTA support). The eNB 160 may send 302 UL/DL reconfiguration signaling to configure a UE 102 with a serving cell. The signaling may indicate a UL/DL configuration for a serving cell to which the UE 102 may reconfigure in the next radio frame. In one implementation, the eNB 160 may send 302 a PDCCH or an EPDCCH transmission in which the UL/DL reconfiguration signaling is encoded. In one implementation, the UL/DL reconfiguration signaling may be a PDCCH or an EPDCCH with a given DCI format.

The eNB 160 may receive 304 feedback for the UL/DL reconfiguration signaling and PDSCH HARQ-ACK information in an uplink subframe corresponding to the PDSCH HARQ-ACK information. The PDSCH HARQ-ACK information may be scheduled to be received in a given UL subframe. The feedback for the UL/DL reconfiguration signaling may be added (by the UE 102) to the PDSCH HARQ-ACK information. Therefore, the eNB 160 may receive the feedback for the UL/DL reconfiguration signaling and the PDSCH HARQ-ACK information if the PDSCH HARQ-ACK information is expected in the UL subframe. In one implementation, the feedback for the UL/DL reconfiguration signaling may be an acknowledgement or negative acknowledgement (ACK/NACK) message, as described above in connection with FIG. 2.

The eNB 160 may perform 306 blind decoding to determine the ACK/NACK feedback of the UL/DL reconfiguration signaling and the PDSCH HARQ-ACK information. In one case, the eNB 160 may decode the feedback for the UL/DL reconfiguration signaling and the PDSCH HARQ-ACK information assuming an ACK for the UL/DL reconfiguration signaling. The decoding is based on a DL subframe or a special subframe in a DL association set of a DL-reference UL/DL configuration. In this case, the DL subframe or the special subframe is determined based on the UL/DL reconfiguration signaling. In other words, if the UL/DL reconfiguration signaling was correctly received by the UE 102, the number of PDSCH HARQ-ACK bits may be determined based on the actual number of DL subframe allocations of the UL/DL configuration indicated by the UL/DL reconfiguration signaling.

The eNB 160 may determine the correctness of the feedback for the UL/DL reconfiguration signaling based on the decoded output. If the eNB 160 determines that the decoded ACK/NACK feedback for the UL/DL reconfiguration signaling is an ACK, the eNB 160 may accept the PDSCH HARQ-ACK information. Therefore, the eNB 160 may also determine the validity of the PDSCH HARQ-ACK information based on the decoded output.

If the eNB 160 determines that the decoded ACK/NACK feedback of the UL/DL reconfiguration signaling is not an ACK, the eNB 160 may decode the feedback for the UL/DL reconfiguration signaling and the PDSCH HARQ-ACK information assuming a NACK for the UL/DL reconfiguration signaling. As with the decoding based on the ACK assumption, this decoding is based on a DL subframe or a special subframe in a DL association set of a DL-reference UL/DL configuration. However, in this case, the DL subframe or the special subframe is determined based on the DL-reference UL/DL configuration. In other words, the number of PDSCH HARQ-ACK bits may be determined based on the DL subframe allocations of the DL-reference UL/DL configuration.

As with the blind decoding based on the ACK assumption, the eNB 160 may determine the correctness of the feedback for the UL/DL reconfiguration signaling and the validity of the PDSCH HARQ-ACK information based on the decoded output. For example, if the eNB 160 determines that the decoded ACK/NACK feedback for the UL/DL reconfiguration signaling is a NACK, the eNB 160 may accept the PDSCH HARQ-ACK information.

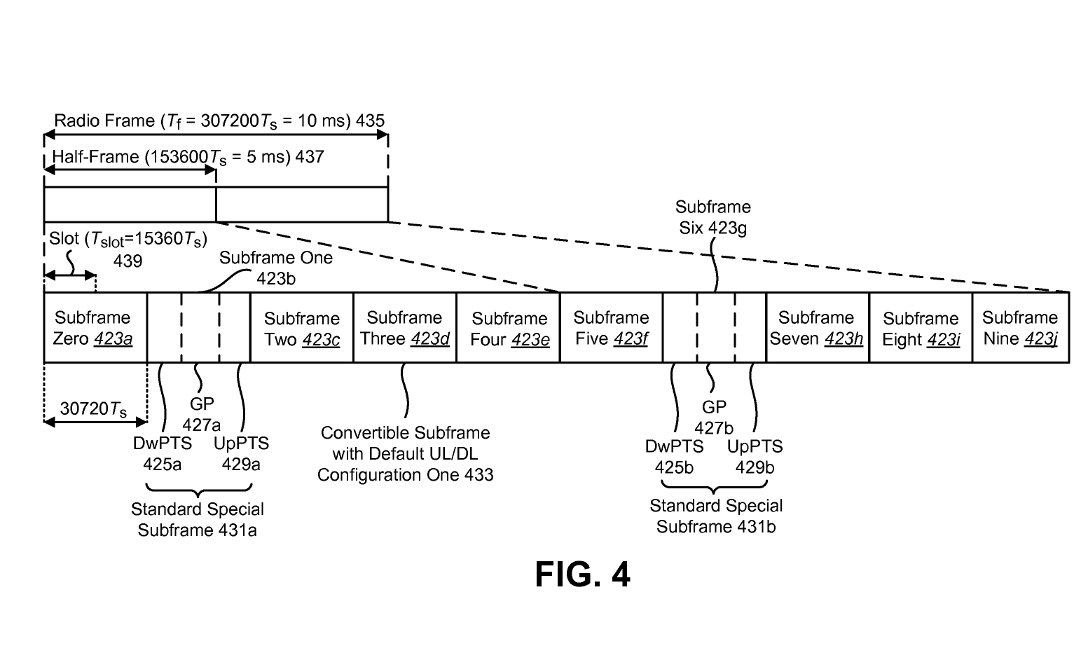

FIG. 4 is a diagram illustrating one example of a radio frame 435 that may be used in accordance with the systems and methods disclosed herein. This radio frame 435 structure illustrates a TDD structure. Each radio frame 435 may have a length of T_{f}=307200·Tₛ=10 ms, where T_{f} is a radio frame 435 duration and Tₛ is a time unit equal to

$$\frac{1}{( 15000 \times 2048 )}$$

seconds. The radio frame 435 may include two half-frames 437, each having a length of 153600·Tₛ=5 ms. Each half-frame 437 may include five subframes 423a-e, 423f-j each having a length of 30720·Tₛ=1 ms.

TDD UL/DL configurations 0-6 are given below in Table (1) (from Table 4.2-2 in 3GPP TS 36.211). UL/DL configurations with both 5 ms and 10 ms downlink-to-uplink switch-point periodicity may be supported. In particular, seven UL/DL configurations are specified in 3GPP specifications, as shown in Table (1) below. In Table (1), “D” denotes a downlink subframe, “S” denotes a special subframe and “U” denotes a UL subframe.

TABLE (1)

| TDD | Downlink- | | | | | | | | | | |
|---|---|---|---|---|---|---|---|---|---|---|---|
| UL/DL | to-Uplink | | | | | | | | | | |
| Configu- | Switch- | | | | | | | | | | |
| ration | Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table (1) above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table (2) (from Table 4.2-1 of 3GPP TS 36.211) subject to the total length of DwPTS, GP and UpPTS being equal to 30720·Tₛ=1 ms. Table (2) illustrates several configurations of (standard) special subframes. Each subframe i is defined as two slots, 2i and 2i+1 of length Tₛₗₒₜ=15360·Tₛ=0.5 ms in each subframe. In Table (2), “cyclic prefix” is abbreviated as “CP” and “configuration” is abbreviated as “Config” for convenience.

TABLE (2)

| | Normal CP in downlink | | | Extended CP in downlink | | |
|---|---|---|---|---|---|---|
| | | UpPTS | | | UpPTS | |
| Special | | Normal | Extended | | Normal | Extended |
| Subframe | | CP in | CP in | | CP in | CP in |
| Config | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

UL/DL configurations with both 5 ms and 10 ms downlink-to-uplink switch-point periodicity are supported. In the case of 5 ms downlink-to-uplink switch-point periodicity, the special subframe exists in both half-frames 437. In the case of 10 ms downlink-to-uplink switch-point periodicity, the special subframe exists in the first half-frame 437 only. Subframes 0 and 5 and DwPTS may be reserved for downlink transmission. UpPTS and the subframe immediately following the special subframe may be reserved for uplink transmission.

In accordance with the systems and methods disclosed herein, some types of subframes 423 that may be used include a downlink subframe, an uplink subframe and a special subframe 431. In the example illustrated in FIG. 4, which has a 5 ms periodicity, two standard special subframes 431a-b are included in the radio frame 435.

The first special subframe 431a includes a downlink pilot time slot (DwPTS) 425a, a guard period (GP) 427a and an uplink pilot time slot (UpPTS) 429a. In this example, the first standard special subframe 431a is included in subframe one 423b. The second standard special subframe 431b includes a downlink pilot time slot (DwPTS) 425b, a guard period (GP) 427b and an uplink pilot time slot (UpPTS) 429b. In this example, the second standard special subframe 431b is included in subframe six 423g. The length of the DwPTS 425a-b and UpPTS 429a-b may be given by Table 4.2-1 of 3GPP TS 36.211 (illustrated in Table (2) above) subject to the total length of each set of DwPTS 425, GP 427 and UpPTS 429 being equal to 30720·Tₛ=1 ms.

Each subframe i 423a-j (where i denotes a subframe ranging from subframe zero 423a (e.g., 0) to subframe nine 423j (e.g., 9) in this example) is defined as two slots, 2i and 2i+1 of length Tₛₗₒₜ=15360·Tₛ=0.5 ms in each subframe 423. For example, subframe zero (e.g., 0) 423a may include two slots, including a first slot 439.

UL/DL configurations with both 5 ms and 10 ms downlink-to-uplink switch-point periodicity may be used in accordance with the systems and methods disclosed herein. FIG. 4 illustrates one example of a radio frame 435 with 5 ms switch-point periodicity. In the case of 5 ms downlink-to-uplink switch-point periodicity, each half-frame 437 includes a standard special subframe 431a-b. In the case of 10 ms downlink-to-uplink switch-point periodicity, a special subframe 431 may exist in the first half-frame 437 only.

Subframe zero (e.g., 0) 423a and subframe five (e.g., 5) 423f and DwPTS 425a-b may be reserved for DL transmission. The UpPTS 429a-b and the subframe(s) immediately following the standard special subframe(s) 431a-b (e.g., subframe two 423c and subframe seven 423h) may be reserved for UL transmission. In one implementation, in a case where multiple cells are aggregated, a UE 102 may assume the same UL/DL configuration across all the cells and that the guard period (GP) of the special subframe(s) in the different cells have an overlap of at least 1456·Tₛ.

One or more of the subframes 423 illustrated in FIG. 4 may be convertible, depending on the UL/DL reconfiguration range. Assuming a default UL/DL configuration 1 as given in Table (1) above, for example, subframe three (e.g., 3) 423d may be a convertible subframe 433 (from UL-to-DL, for instance).

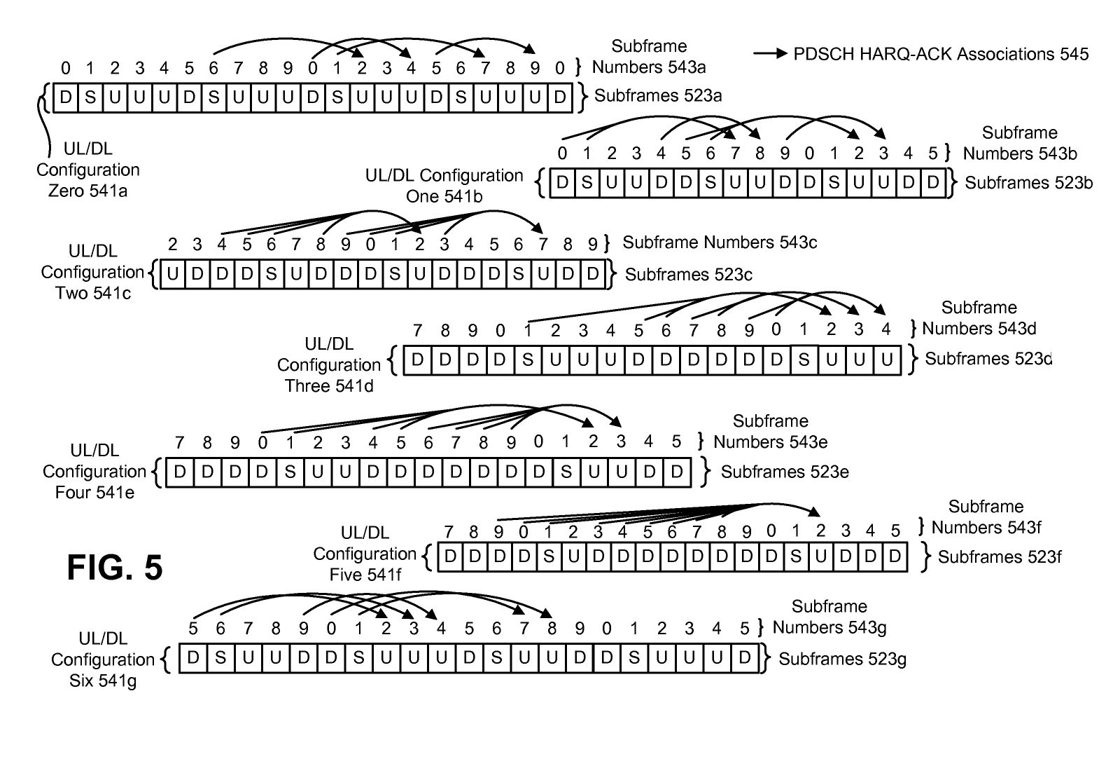

FIG. 5 is a diagram illustrating TDD UL/DL configurations 541a-g in accordance with the systems and methods described herein. In particular, FIG. 5 illustrates UL/DL configuration zero 541a (e.g., “UL/DL configuration 0”) with subframes 523a and subframe numbers 543a, UL/DL configuration one 541b (e.g., “UL/DL configuration 1”) with subframes 523b and subframe numbers 543b, UL/DL configuration two 541c (e.g., “UL/DL configuration 2”) with subframes 523c and subframe numbers 543c and UL/DL configuration three 541d (e.g., “UL/DL configuration 3”) with subframes 523d and subframe numbers 543d. FIG. 5 also illustrates UL/DL configuration four 541e (e.g., “UL/DL configuration 4”) with subframes 523e and subframe numbers 543e, UL/DL configuration five 541f (e.g., “UL/DL configuration 5”) with subframes 523f and subframe numbers 543f and UL/DL configuration six 541g (e.g., “UL/DL configuration 6”) with subframes 523g and subframe numbers 543g.

Furthermore, FIG. 5 illustrates PDSCH HARQ-ACK associations 545 (e.g., PDSCH HARQ-ACK feedback on PUCCH or PUSCH associations). The PDSCH HARQ-ACK associations 545 may indicate HARQ-ACK reporting subframes corresponding to subframes for PDSCH transmissions (e.g., subframes in which PDSCH transmissions may be sent and/or received). The PDSCH HARQ-ACK associations 545 may indicate the association sets and timing for the transmission of PDSCH HARQ-ACK information. It should be noted that some of the radio frames illustrated in FIG. 5 have been truncated for convenience.

The systems and methods described herein may be applied to one or more of the UL/DL configurations 541a-g illustrated in FIG. 5. For example, one or more PDSCH HARQ-ACK associations 545 corresponding to one of the UL/DL configurations 541a-g illustrated in FIG. 5 may be applied to communications between a UE 102 and eNB 160. For example, a DL-reference UL/DL configuration 541 may be determined (e.g., assigned to, applied to) for a serving cell. In this case, PDSCH HARQ-ACK associations 545 may specify PDSCH HARQ-ACK timing (e.g., a HARQ-ACK reporting subframe) for HARQ-ACK feedback transmissions corresponding to the serving cell.

A PDSCH HARQ-ACK association 545 may specify a particular (PDSCH HARQ-ACK) timing for receiving HARQ-ACK information corresponding to a PDSCH. A PDSCH HARQ-ACK association 545 may specify a reporting subframe in which the UE 102 reports (e.g., transmits) the HARQ-ACK information corresponding to the PDSCH to the eNB 160. The reporting subframe may be determined based on the subframe that includes the PDSCH sent by the eNB 160.

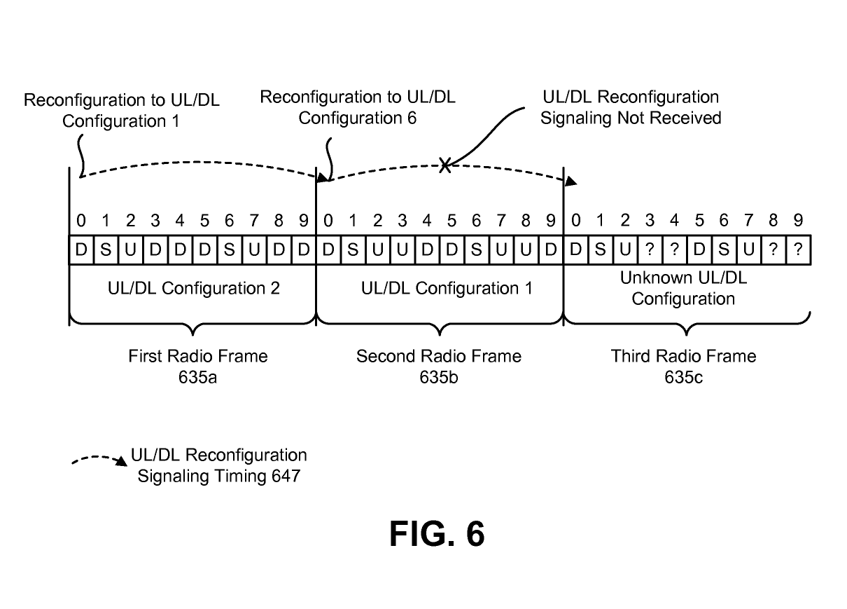

FIG. 6 is a diagram illustrating one example of reconfiguration signaling. In some implementations of dynamic UL/DL reconfiguration, explicit physical (PHY) layer signaling may indicate a UL/DL reconfiguration on a PDCCH and/or an EPDCCH. It should be noted that PHY layer signaling may also be referred to as layer 1 signaling. For the PHY layer signaling, the time scale may be on the order of 10 ms or less. In one implementation, the UL/DL configuration may be signaled in one or more subframes (e.g., subframe 0, 1, 5, and/or 6) of a radio frame 635 to indicate the UL/DL configuration of the next radio frame 635. Therefore, the new UL/DL configuration may be used one radio frame 635 after the UL/DL reconfiguration signaling. With explicit PHY layer signaling, the UL/DL reconfiguration signaling may use a UE-group-common PDCCH and/or EPDCCH.

An important issue for a dynamic UL/DL reconfiguration cell is scheduling and HARQ-ACK timing for eIMTA. With explicit UL/DL reconfiguration signaling, the actual UL/DL configuration in a radio frame 635 is known to a UE 102. The term “actual UL/DL configuration” refers to the UL/DL configuration indicated by the UL/DL reconfiguration signaling. There are two approaches for dynamic UL/DL reconfiguration timing. In a first approach, a separate DL-reference UL/DL configuration and UL-reference UL/DL configuration may be defined for a dynamic UL/DL reconfiguration cell. In this first approach, the PDSCH HARQ-ACK timing may follow the DL-reference UL/DL configuration. The PUSCH scheduling and PUSCH HARQ-ACK timing may follow the UL-reference UL/DL configuration.

In a second approach, a transition from the current UL/DL configuration to a new UL/DL configuration may be performed based on the UL/DL reconfiguration signaling. In this second approach, new timing may be defined for the transition between different UL/DL configurations.

Reliability issues may exist with explicit PHY layer UL/DL reconfiguration signaling. In some implementations, the explicit PHY layer UL/DL reconfiguration signaling by a PDCCH or an EPDCCH may indicate the UL/DL configuration of a coming radio frame 635. In one case, the UL/DL reconfiguration signaling may be present in every radio frame 635 in a dynamic UL/DL reconfiguration cell. In another case, the UL/DL reconfiguration signaling may be signaled only when the UL/DL configuration is changed for a dynamic UL/DL reconfiguration cell.

However, in either case, the UE 102 may not detect or may not correctly detect the UL/DL reconfiguration signaling. For example, the UE 102 may not receive a UE-group common PDCCH or EPDCCH for the UL/DL reconfiguration. Alternatively, the UE 102 may fail to correctly decode the UE-group common PDCCH or EPDCCH for the UL/DL reconfiguration. Therefore, the UE 102 may have a different understanding from the eNB 160 about the UL/DL configuration in a radio frame 635. In this case, the UE 102 may not know what UL/DL configuration should be used in the next radio frame 635.

An example of reconfiguration signaling is illustrated in FIG. 6. In this example, the reconfiguration signaling timing 647 for three radio frames 635a-c is shown. In the first radio frame 635a a serving cell is configured with UL/DL configuration 2 as the DL-reference UL/DL configuration and UL/DL configuration 0 as the DL-reference UL/DL configuration. UL/DL reconfiguration signaling is transmitted in subframe 0 of each radio frame 635. In one implementation, the UL/DL reconfiguration signaling may be a UE-group specific PDCCH or EPDCCH.

In this example, UL/DL reconfiguration signaling indicating a reconfiguration to UL/DL configuration 1 is transmitted in subframe 0 of the first radio frame 635a. This UL/DL reconfiguration signaling is correctly detected and the UE 102 performs the reconfiguration to UL/DL configuration 1 for the second radio frame 635b. However, the UL/DL reconfiguration signaling indicating a reconfiguration to UL/DL configuration 6 is not correctly received (e.g., detected or decoded) in subframe 0 of the second radio frame 635b. Therefore, the UE 102 does now know which UL/DL configuration to apply for the third radio frame 635c. In this case, the subframe type for subframes 3, 4, 8 and 9 are unknown (as indicated by a “?” in FIG. 6.) This may cause mistakes in cell operations. The problem is more serious for the second approach for HARQ-ACK timing with a transition between different UL/DL configurations.

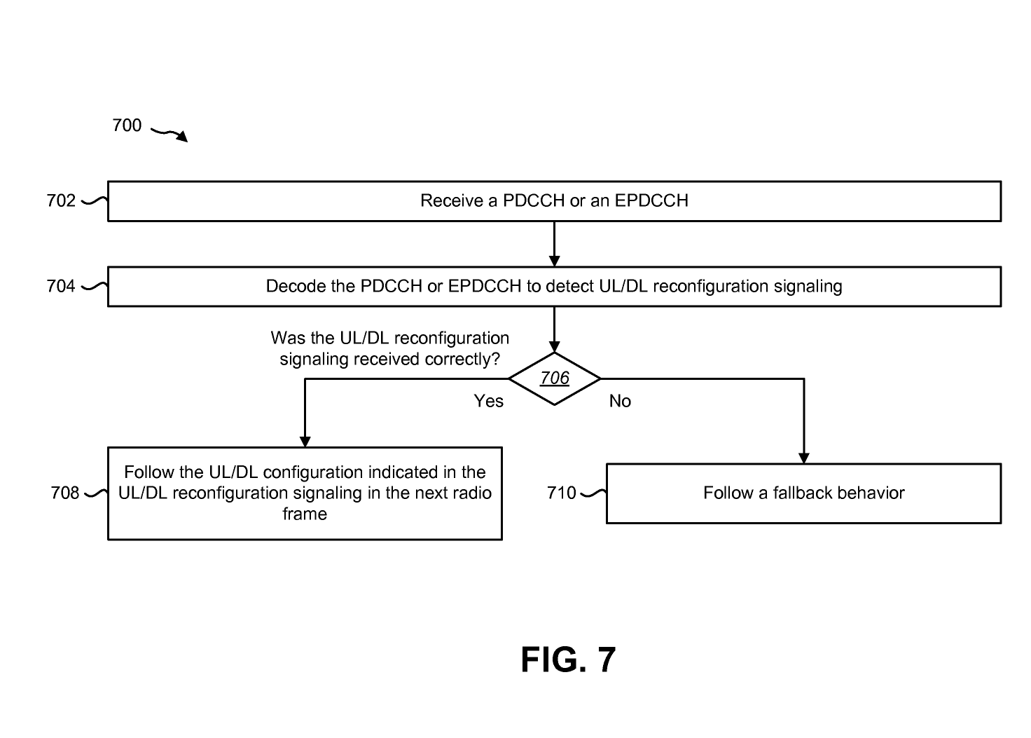

FIG. 7 is a flow diagram illustrating another implementation of a method 700 for reconfiguration signaling by a UE 102. In particular, FIG. 7 illustrates fallback behavior for the UE 102 in the event that the UE 102 does correctly receive UL/DL reconfiguration signaling. As compared with the transition-based approach for dynamic UL/DL reconfiguration, the separate DL-reference UL/DL configuration and UL-reference UL/DL configuration approach is more robust for dynamic UL/DL reconfiguration cells. The DL-reference UL/DL configuration and UL-reference UL/DL configuration may be configured by a higher layer. The DL-reference UL/DL configuration and UL-reference UL/DL configuration and may be maintained regardless of UL/DL reconfigurations.

An eNB 160 may indicate the UL/DL configuration of the next radio frame 435 by explicit UL/DL reconfiguration signaling. The UL/DL reconfiguration signaling may be transmitted every 10 ms. The UL/DL reconfiguration signaling may be repeated in a radio frame 435. For example, subframe 0 and subframe 5 may be used for explicit UL/DL reconfiguration signaling and the same UL/DL configuration may be signaled in both subframes. The eNB 160 may follow the subframe allocation in the UL/DL configuration indicated by the UL/DL reconfiguration signaling. A UE 102 may also follow the UL/DL configuration in the UL/DL reconfiguration signaling if the UL/DL reconfiguration signaling is decoded correctly. However, the UE 102 behavior should be defined if the explicit UL/DL reconfiguration signaling is not detected correctly. For example, the UE 102 behavior may be implicitly defined based on PDCCH or EPDCCH scheduling.

In one implementation of reconfiguration signaling, the UE 102 may receive 702 a PDCCH or an EPDCCH. The PDCCH or EPDCCH may be received 702 from an eNB 160.

The UE 102 may decode 704 the PDCCH or EPDCCH to detect UL/DL reconfiguration signaling. For example, the UE 102 may decode 704 the downlink control information (DCI) of the PDCCH or the EPDCCH in one or more predefined or configured subframes (e.g. in subframe 0 of each radio frame 435) to detect the UL/DL reconfiguration signaling. In the case of multiple subframes, explicit UL/DL reconfiguration signaling may be determined based on multiple PDCCHs or EPDCCHs in multiple subframes.

The UE 102 may determine 706 whether the UL/DL reconfiguration signaling was received correctly. For example, the UE 102 may determine 706 whether the UL/DL reconfiguration signaling is detected on the PDCCH or EPDCCH. The UE 102 may also determine 706 whether the UL/DL reconfiguration signaling was decoded correctly.

If the UE 102 determines 706 that the UL/DL reconfiguration signaling was received correctly, then the UE 102 may follow 708 the UL/DL configuration indicated by the UL/DL reconfiguration signaling in the next radio frame 435. For example, UE 102 may follow 708 the subframe type allocation (e.g., UL, DL, or special) in the radio frame 435 based on the UL/DL configuration indicated by the UL/DL reconfiguration signaling.

The UE 102 may receive a subframe indicated as a DL subframe or a special subframe based on the UL/DL configuration indicated by the UL/DL reconfiguration signaling. In this case, the UE 102 may receive a subframe to decode a PDCCH or EPDCCH. The UE 102 may also receive the subframe to decode a PDSCH, if scheduled.

If the UE 102 receives a UL grant (e.g. DCI format 0/4) corresponding to a subframe indicated as a DL subframe by the UL/DL configuration of the UL/DL reconfiguration signaling, the UE 102 may ignore the UL grant and may not transmit a UL signal. In this case, the UL grant may be treated as an error case. However, if the UE 102 receives a UL grant (e.g. DCI format 0/4) corresponding to a subframe indicated as a UL subframe by the UL/DL configuration of the UL/DL reconfiguration signaling, the UE 102 may transmit a UL signal.

If the UE 102 determines 706 that the UL/DL reconfiguration signaling was not received correctly (e.g., the UL/DL reconfiguration signaling was not detected and/or decoded correctly), the UE 102 may follow 710 a fallback behavior. The fallback behavior may include multiple fallback approaches.

A first fallback approach involves limited subframe usage. In this approach, the UE 102 may only receive fixed DL or special subframes. Furthermore, the UE 102 may only transmit in fixed UL or special subframes. In one implementation, the fixed special, DL and UL subframes may be defined. For example, subframes 1 and 6 may be defined as fixed special subframes, subframes 0, 1, 5 and 6 may be defined as fixed DL subframes and subframe 2 may be defined as fixed UL subframes. In another implementation, the fixed subframes may be determined based on the common type subframes in the DL-reference UL/DL configuration and UL-reference UL/DL configuration of the dynamic UL/DL reconfiguration cell.

A fixed subframe is a subframe that cannot change directions. As used herein, the special subframe and downlink subframe are treated as the same direction. A flexible subframe is a subframe that may be configured as a DL/special subframe or a UL subframe (e.g., a subframe indicated as a UL subframe by the UL-reference UL/DL configuration and as a DL/special subframe by the DL-reference UL/DL configuration). In this first approach, the UE 102 may consider a subframe as a DL/special subframe if the subframe is a fixed DL/special subframe. The UE 102 may not receive flexible subframes as DL. In other words, the UE 102 may not monitor PDCCH or EPDCCH and/or may not decode PDSCH and/or may not perform channel measurement in a flexible subframe. Furthermore, according to this first approach, if the UE 102 receives a UL grant corresponding to a flexible subframe, the UE 102 may ignore the flexible subframe and may not transmit a UL signal.

A second fallback approach involves limited subframe usage based on a specified (e.g., default) UL/DL configuration. In one implementation, the UL/DL configuration may be specified by a UL/DL configuration in system information block (SIB) or radio resource control (RRC) signaling. In the case where the dynamic UL/DL reconfiguration cell is a primary cell (PCell), the UL/DL configuration may be specified by a UL/DL configuration in SystemInformationBlockType1 or RadioResourceConfigCommon signaling. In the case where the dynamic UL/DL reconfiguration cell is a secondary cell (SCell), the UL/DL configuration may be specified by a UL/DL configuration in RadioResourceConfigCommonSCell-r10 signaling. In another implementation, the UL/DL configuration may be specified by a UL-reference UL/DL configuration of the dynamic UL/DL reconfiguration cell.

In this second approach, the UE 102 may consider a subframe as a DL/special subframe if the subframe is a DL/special subframe allocated in the specified UL/DL configuration. The UE 102 may receive the DL/special subframes allocated in the specified UL/DL configuration. Furthermore, according to this second approach, if the UE 102 receives a UL grant for a DL/special subframe allocated in the specified UL/DL configuration, the UE 102 may ignore the subframe and may not transmit a UL signal.

A third fallback approach involves flexible usage of subframes by implicit signaling based on PDCCH or EPDCCH DCI formats. In this approach, the actual use of the subframes may be determined implicitly by PDCCH or EPDCCH DCI formats. For example, the UE 102 may determine the subframe type (e.g., downlink subframe, uplink subframe, or special subframe) of the subframe based on a predetermined UL/DL configuration (e.g., TDD UL/DL configuration, DL-reference UL/DL configuration, or UL-reference UL/DL configuration). Additionally or alternatively, the UE 102 may determine the subframe type based on the UL grant and/or PHICH for the subframe such that the subframe for which the UL grant and/or PHICH indicates PUSCH transmission is an UL subframe or a special subframe that is used for PUSCH transmission and the subframe for which the UL grant and/or PHICH do not indicate PUSCH transmission is a predetermined subframe type of the predetermined UL/DL configuration.

If the UE 102 receives a UL grant in a flexible subframe, the UE 102 may use the flexible subframe as UL and may transmit a UL signal as scheduled. Otherwise, the UE 102 may consider a subframe as a DL/special subframe and may receive the subframe if there is no UL grant scheduled for the given flexible subframe or if the subframe is a fixed DL/special subframe. This third fallback approach may provide better subframe usage and flexibility than the first fallback approach.

The first and second fallback approaches may reduce the number of usable subframes, but will not cause interference to other UEs 102 since all flexible subframes are disabled. The third fallback approach is more flexible and may provide better spectrum usage. However, in some cases, a UE 102 following the third fallback approach may cause interference to other UEs 102. For example, the UE 102 may miss the UL/DL reconfiguration signaling that indicates a subframe as a DL subframe, and the UE 102 may receive a false UL grant in the given subframe. In this case, the UE 102 may transmit a UL signal in the given subframe and may cause interference to the DL reception of other UEs 102 in the same cell.

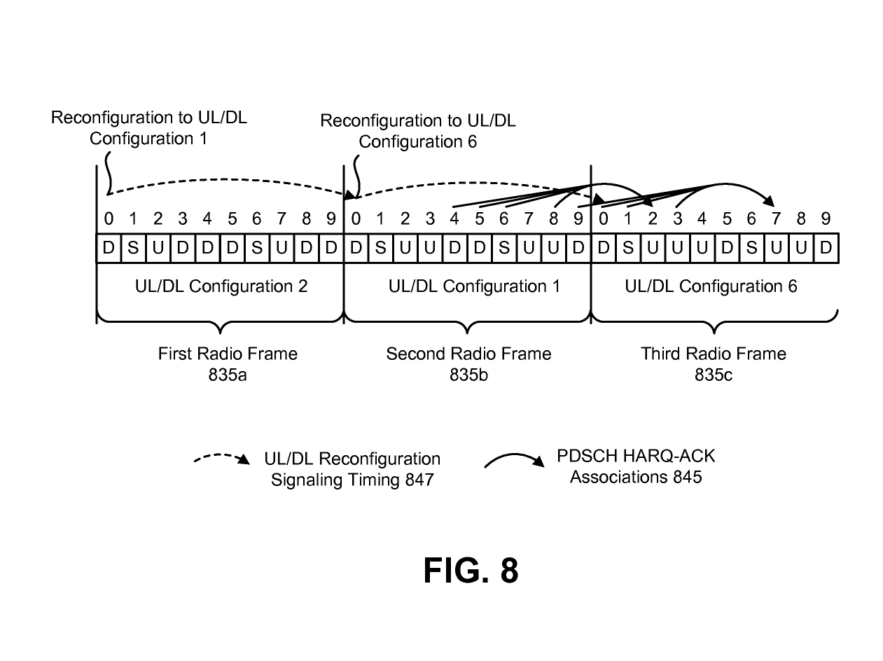

FIG. 8 is a diagram illustrating another implementation of reconfiguration signaling. In this example, the reconfiguration signaling timing 847 for three radio frames 835a-c is shown. PDSCH HARQ-ACK associations 845 are also shown.

An eNB 160 may follow the UL/DL configuration indicated in the UL/DL reconfiguration signaling. However, the eNB 160 should have the capability to receive feedback information (e.g. PDSCH HARQ-ACK information) from a UE 102 regardless of whether the UL/DL reconfiguration signaling is correctly received at the UE 102. In the systems and methods described herein, PDSCH HARQ-ACK reporting may follow the DL-reference UL/DL configuration of the serving cell to determine the DL association set, as in Table (3) (from Table 10.1.3.1-1 of 3GPP TS 36.213). Table (3) provides a downlink association set index K: {k₀, k₁, . . . k_{M-1}}.

TABLE (3)

| UL/DL | | | | | | | | | | |
|---|---|---|---|---|---|---|---|---|---|---|
| Configu- | Subframe n | | | | | | | | | |
| ration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, | — | — | — | — | 8, 7, | — | — |
| | | | 4, 6 | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

As one way to report the PDSCH HARQ-ACK, the number of subframes included in the PDSCH HARQ-ACK reporting should be M, where M is the number of elements in the set K defined in Table (3) for the DL-reference UL/DL configuration of the dynamic UL/DL reconfiguration cell. This may provide the correct understanding between the eNB 160 and the UE 102. On the other hand, the number of PDSCH HARQ-ACK bits may become large because all M subframes in the DL association set should be included in the report. The number of PDSCH HARQ-ACK bits may become very large if UL/DL configuration 5 is used as the DL-reference UL/DL configuration. Furthermore, the traditional PDSCH HARQ-ACK reporting cannot indicate whether the UL/DL reconfiguration signaling is correctly received or not.

The reliability of PDSCH HARQ-ACK reporting may be enhanced by adding an acknowledgment for the UL/DL reconfiguration signaling. The acknowledgement from the UE 102 may indicate the correct reception of UL/DL reconfiguration signaling related to the DL association set of the reporting UL subframe. Therefore, an acknowledgement (ACK) or negative acknowledgement (NACK) of the UL/DL reconfiguration signaling may indicate the reliability of the UL/DL reconfiguration signal to the eNB 160. Based on the acknowledgment (e.g., the ACK/NACK message), the eNB 160 may adjust the PDCCH/EPDCCH redundancy accordingly.

Furthermore, the UE 102 and the eNB 160 may optimize the PDSCH HARQ-ACK reporting by reducing the number of PDSCH HARQ-ACK bits in PDSCH HARQ-ACK reporting on PUCCH or PUSCH. In some implementations, the DL-reference UL/DL configuration may provide the maximum number of DL subframes allowed for a UL/DL reconfiguration. For a PDSCH HARQ-ACK transmission on PUCCH or non-adjusted PUSCH reporting, all M subframes in the DL association set of the DL-reference UL/DL configuration may be included in the report (e.g., the PDSCH HARQ-ACK information). However, the actual allocated number of DL subframes in the UL/DL reconfiguration signaling may be lower than the M subframes of the DL-reference UL/DL configuration. By acknowledging the UL/DL reconfiguration signaling, a UE 102 may report only the number of DL subframes in the actual UL/DL configuration based on the DL association set.

An example of feedback for the UL/DL reconfiguration signaling is illustrated in FIG. 8. Explicit UL/DL reconfiguration signaling may indicate which UL/DL configuration should be applied in a radio frame 835. In one implementation, explicit PHY layer UL/DL reconfiguration signaling by a UE-group PDCCH or EPDCCH may be be signaled in each radio frame 835 to indicate the UL/DL configuration of the next radio frame 835.

In FIG. 8, a dynamic UL/DL reconfiguration cell is reconfigured from UL/DL configuration 2 in the first radio frame 835a to UL/DL configuration 1 in the second radio frame 835b. The dynamic UL/DL reconfiguration cell is then reconfigured to UL/DL configuration 6 in the third radio frame 835c. These reconfigurations are indicated by UL/DL reconfiguration signaling in subframe 0 of each radio frame 835. In this example, the DL-reference UL/DL configuration is UL/DL configuration 2 and the UL-reference UL/DL configuration is UL/DL configuration 0. The PDSCH HARQ-ACK associations 845 follow the DL-reference UL/DL configuration 2 in this example.

The feedback for the UL/DL reconfiguration signaling may include an ACK/NACK message for one or more UL/DL reconfiguration signals in one or more radio frames 835 based on the DL association set. Thus, the feedback for the UL/DL reconfiguration signaling (e.g., the ACK/NACK message) may report the correct understanding of the subframe allocations in a DL association set. It should be noted that the feedback for the UL/DL reconfiguration signaling may not necessarily acknowledge the most recent UL/DL reconfiguration signaling. For example in the case where a DL association set spans more than one radio frame 835, the feedback for the UL/DL reconfiguration signaling may be associated with multiple UL/DL reconfiguration signals.

If any subframe in a radio frame 835 is included the DL association set of a given UL subframe, the UL/DL reconfiguration signal for the radio frame 835 should be included in the feedback for the UL/DL reconfiguration signaling. If multiple radio frames 835 are included in the DL association set of a UL subframe, an AND operation of the ACK/NACK message for the UL/DL reconfiguration signaling of each radio frame 835 may be performed to generate the feedback for the UL/DL reconfiguration signaling. Therefore, an ACK may be reported only if the UL/DL reconfiguration signaling of all the radio frames 835 included in the DL association set are correctly received.

In FIG. 8, for UL subframe 2 in the third radio frame 835c, all the subframes in the DL association set belong to the second radio frame 835b. Therefore, an ACK for the UL/DL reconfiguration signaling is generated if the UL/DL reconfiguration signaling in the first radio frame 835a is correctly received. In this case, if the UL/DL reconfiguration signaling in the first radio frame 835a is correctly received, the UE 102 knows the actual allocation of DL subframes in the second radio frame 835b. Otherwise, if the UL/DL reconfiguration signaling in the first radio frame 835a is not correctly received, a NACK should be generated.

For UL subframe 7 in the third radio frame 835c, the subframes in the DL association set of the DL-reference UL/DL configuration belong to both the second radio frame 835b and the third radio frame 835c. Therefore, an ACK for the UL/DL reconfiguration signaling is generated if both the UL/DL reconfiguration signaling in the first radio frame 835a and the UL/DL reconfiguration signaling in the second radio frame 835b are correctly received. In this case, if both the UL/DL reconfiguration signaling in the first radio frame 835a and the UL/DL reconfiguration signaling in the second radio frame 835b are correctly received, the UE 102 knows the actual allocation of DL subframes in both second radio frame 835b and the third radio frame 835c. If either of the UL/DL reconfiguration signaling in the first radio frame or the second radio frame 835b is not received and decoded correctly, the UE 102 may generate a NACK.

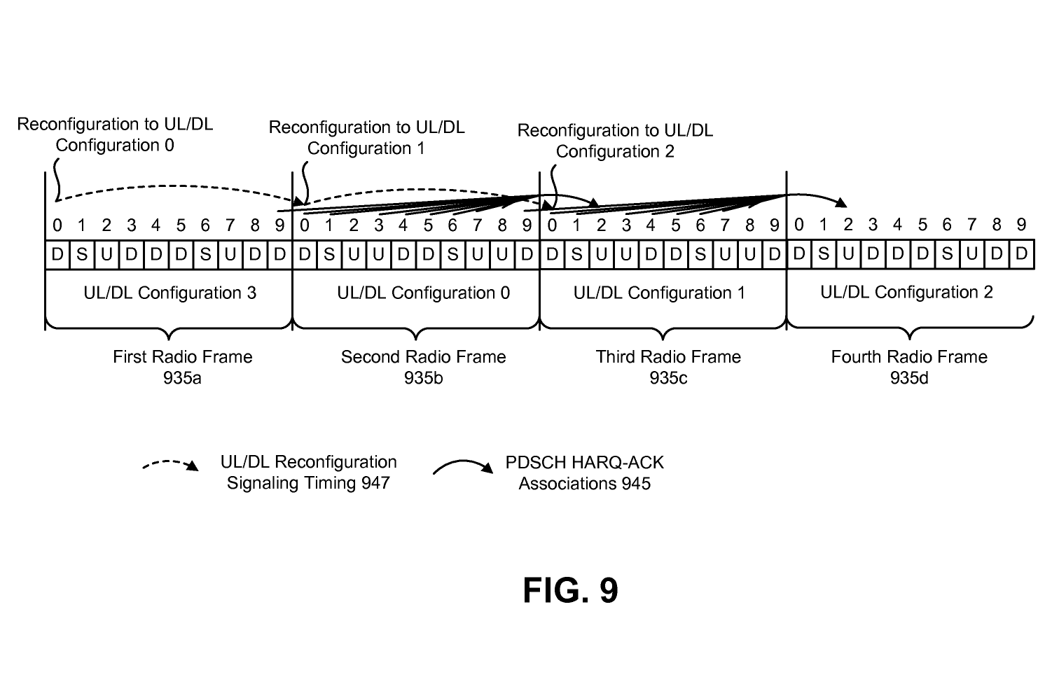

FIG. 9 is a diagram illustrating yet another implementation of reconfiguration signaling. In this example, the reconfiguration signaling timing 947 for four radio frames 935a-d is shown. PDSCH HARQ-ACK associations 945 are also shown. In this example, the DL-reference UL/DL configuration is UL/DL configuration 5 and the UL-reference UL/DL configuration is UL/DL configuration 0.

A dynamic UL/DL reconfiguration cell is reconfigured from UL/DL configuration 3 in the first radio frame 935a to UL/DL configuration 0 in the second radio frame 935b. The dynamic UL/DL reconfiguration cell is reconfigured to UL/DL configuration 1 in the third radio frame 935c. The dynamic UL/DL reconfiguration cell is then reconfigured to UL/DL configuration 2 in the fourth radio frame 935d. These reconfigurations are indicated by UL/DL reconfiguration signaling in subframe 0 of each radio frame 935. The PDSCH HARQ-ACK associations 945 follow the DL-reference UL/DL configuration 5.

In this example, the DL association set for subframe 2 in the fourth radio frame 935d includes subframes from the second radio frame 935b and third radio frame 935c. Therefore, an ACK for UL/DL reconfiguration signaling is generated if both the UL/DL reconfiguration signaling in the first radio frame 935a and second radio frame 935b are correctly received. In this case, if both the UL/DL reconfiguration signaling in the first radio frame 935a and the UL/DL reconfiguration signaling in the second radio frame 935b are correctly received, the UE 102 knows the actual allocation of DL subframes in both second radio frame 935b and the third radio frame 935c. If any of the UL/DL reconfiguration signaling in the first radio frame 935a or the second radio frame 935b is not received and decoded correctly, the UE 102 may generate a NACK.

As discussed above, if the UE 102 receives the UL/DL reconfiguration signaling correctly, the UE 102 may have knowledge of the actual allocation of the subframes in the DL association set. Therefore, the UE 102 may report PDSCH HARQ-ACK information based on the actual DL allocations in the association set instead of using M for all subframes in the association set. For example, in FIG. 9, if M of the DL-reference UL/DL configuration 5 is used, 9 bits need to be reported in subframe 2 of a radio frame 935 even if some of the subframes are not allocated as DL. However, the UE 102 may also send feedback (an ACK/NACK message, for instance) to the eNB 160 to indicate the whether a UL/DL reconfiguration signaling is correctly received.

Therefore, if the feedback for the UL/DL reconfiguration signaling is reported to eNB 160, the UE 102 may use the actual number of DL subframes in each association set in the PDSCH HARQ-ACK report (instead of using M for all subframes in the association set). For example, in FIG. 9, the number of DL subframes associated with subframe 2 of the third radio frame 935c is 5, and the number of DL subframes associated with subframe 2 of the fourth radio frame 935d is 6. It should be noted that the number of DL subframes may be different because of different UL/DL configurations in different radio frames 935. Therefore, the number of bits in a PDSCH HARQ-ACK transmission may be reduced, and PDSCH HARQ-ACK reporting performance may be enhanced.

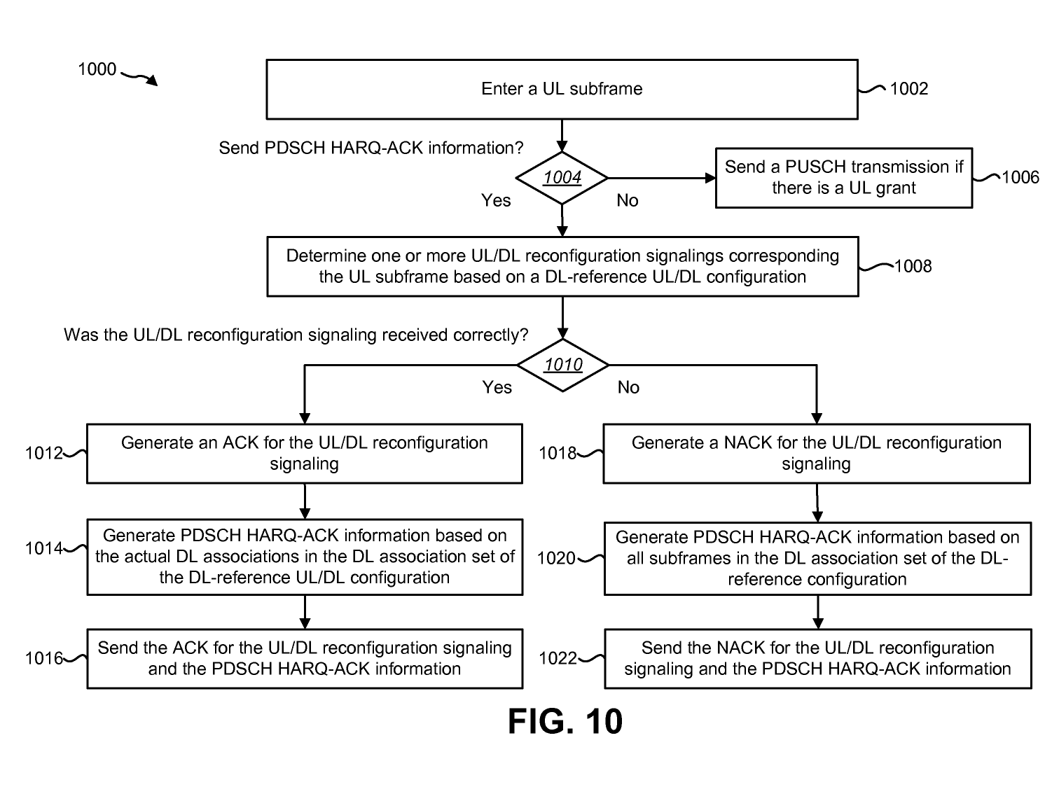

FIG. 10 is a flow diagram illustrating yet another implementation of a method 1000 for reconfiguration signaling by a UE 102. In particular, FIG. 10 illustrates sending feedback for UL/DL reconfiguration signaling.

The UE 102 may enter 1002 a UL subframe. The UE 102 may determine 1004 whether to send (e.g., report) PDSCH HARQ-ACK information in the UL subframe. For example, the UL subframe may be designated (according to a UL/DL configuration) for transmission of uplink control information (UCI) on a PUCCH and/or PUSCH. Therefore, the UE 102 may determine 1004 whether to send PDSCH HARQ-ACK information based on the PDSCH HARQ-ACK associations 545 of a UL/DL configuration. In one implementation, the UE 102 may determine 1004 whether to send PDSCH HARQ-ACK information based on the detection of a PDSCH transmission or a PDCCH/EPDCCH indicating a downlink semi-persistent scheduling (SPS) release within subframes n-k for a serving cell c, where k E K intended for the UE 102. If the UE 102 determines 1004 that PDSCH HARQ-ACK information is not to be sent, then the UE 102 may send 1006 a PUSCH transmission if there is a UL grant associated with the UL subframe.

If the UE 102 determines 1004 that PDSCH HARQ-ACK information is to be sent, the UE 102 may determine 1008 one or more related UL/DL reconfiguration signalings corresponding to the UL subframe based on a DL-reference UL/DL configuration. For example, the UE 102 may determine 1008 all UL/DL reconfiguration signalings corresponding to each of the subframes in a DL association set of the DL-reference UL/DL configuration.

The UE 102 may determine 1010 whether each UL/DL reconfiguration signaling corresponding to the UL subframe was received correctly. In one implementation, the UE 102 may determine whether each UL/DL reconfiguration signaling was detected. If each UL/DL reconfiguration signaling was detected, the UE 102 may determine whether each UL/DL reconfiguration signaling was decoded correctly.

If each UL/DL reconfiguration signaling corresponding to the UL subframe was received correctly, then the UE 102 may generate 1012 an ACK for the UL/DL reconfiguration signaling. Feedback for UL/DL reconfiguration signaling may ensure a correct understanding between the UE 102 and an eNB 160. To facilitate dynamic UL/DL reconfiguration, the DL-reference UL/DL configuration may define an allowed UL/DL configuration with the most DL subframes. The number of DL subframes in a DL association set may be larger than the actual DL allocations. Thus, adding feedback for the UL/DL reconfiguration signaling may actually decrease the total number of bits reported on a PUCCH or PUSCH.

In one implementation, the feedback for the UL/DL reconfiguration signaling may include an ACK/NACK message. The ACK/NACK message may include an ACK/NACK bit that indicates an ACK or a NACK for the UL/DL reconfiguration signaling. The UE 102 may generate 1012 an ACK to acknowledge that each UL/DL reconfiguration signaling corresponding to the UL subframe was received correctly.

The UE 102 may generate 1014 PDSCH HARQ-ACK information based on the actual DL allocations in the DL association set of the DL-reference configuration. In one implementation, M_{c} is the number of elements in set K_{c} associated with subframe n for serving cell c. The DL/special subframes reported in the PDSCH HARQ-ACK are based on K_{c}. The number of DL/special subframes reported in the PDSCH HARQ-ACK may be based on M_{c}. Set K_{c} may contain values of k E K such that subframe n-k corresponds to a DL subframe or a special subframe for serving cell c, where the DL subframe or the special subframe may be determined based on the UL/DL reconfiguration signaling and defined in Table (3) based on DL-reference UL/DL configuration. In other words, if the UL/DL reconfiguration signaling was correctly received by the UE 102, the number of PDSCH HARQ-ACK bits may be determined based on the actual number of DL subframe allocations of the UL/DL configuration indicated by the UL/DL reconfiguration signaling.

The UE 102 may send 1016 the ACK for the UL/DL reconfiguration signaling and the PDSCH HARQ-ACK information. The ACK for the UL/DL reconfiguration signaling may be reported together with PDSCH HARQ-ACK information for a UE 102 that supports dynamic UL/DL reconfiguration. To report the ACK/NACK bit for the UL/DL reconfiguration signaling, the ACK/NACK bit may be added to PDSCH HARQ-ACK bits in a PUCCH or PUSCH reporting.

In one case, the ACK/NACK bit for the UL/DL reconfiguration signaling may be added before the PDSCH HARQ-ACK bit sequence. The aggregated bits (e.g., the ACK/NACK bit for the UL/DL reconfiguration signaling and the PDSCH HARQ-ACK bits) may then be encoded and transmitted on a PUCCH or PUSCH. This may reduce codeword space for the decoder since discontinuous transmission (DTX) bits may be padded for a DL subframe if there is no PDSCH scheduled for a given UE 102.

In another case, the ACK/NACK bit for the UL/DL reconfiguration signaling may be added after the PDSCH HARQ-ACK bit sequence. The aggregated bits of the PDSCH HARQ-ACK bits and the ACK/NACK bit for the UL/DL reconfiguration signaling may then be encoded and transmitted on a PUCCH or PUSCH.

If the UE 102 determines 1010 that a UL/DL reconfiguration signaling corresponding to the UL subframe was not received correctly, then the UE 102 may generate 1018 a NACK for the UL/DL reconfiguration signaling. The UE 102 may generate 1018 the NACK to indicate to the eNB 160 that at least one of the UL/DL reconfiguration signalings corresponding to the UL subframe was not received correctly.

The UE 102 may generate 1020 PDSCH HARQ-ACK information based on all DL allocations in the DL association set of the DL-reference configuration. In this case, the number of DL/special subframes reported in the PDSCH HARQ-ACK bits may be based on the number of DL subframes and special subframes in the DL association set corresponding to the DL-reference UL/DL configuration. In one implementation, the DL subframe or the special subframe may be determined based on the DL-reference UL/DL configuration. In another implementation, the DL subframe or the special subframe may be a fixed DL subframe or a fixed special subframe. In yet another implementation, the DL subframe or the special subframe may be determined based on a TDD UL/DL configuration. For example, the TDD UL/DL configuration may be indicated in a SystemInformationBlockType1, a RadioResourceConfigCommon or a RadioResourceConfigCommonSCell-r10 signal. In another example, the TDD UL/DL configuration may be based on the UL-reference UL/DL configuration of the dynamic UL/DL reconfiguration cell.

The UE 102 may send 1022 the NACK for the UL/DL reconfiguration signaling and the PDSCH HARQ-ACK information. In one case, the ACK/NACK bit for the UL/DL reconfiguration signaling may be added before the PDSCH HARQ-ACK bit sequence. In another case, the ACK/NACK bit for the UL/DL reconfiguration signaling may be added after the PDSCH HARQ-ACK bit sequence.

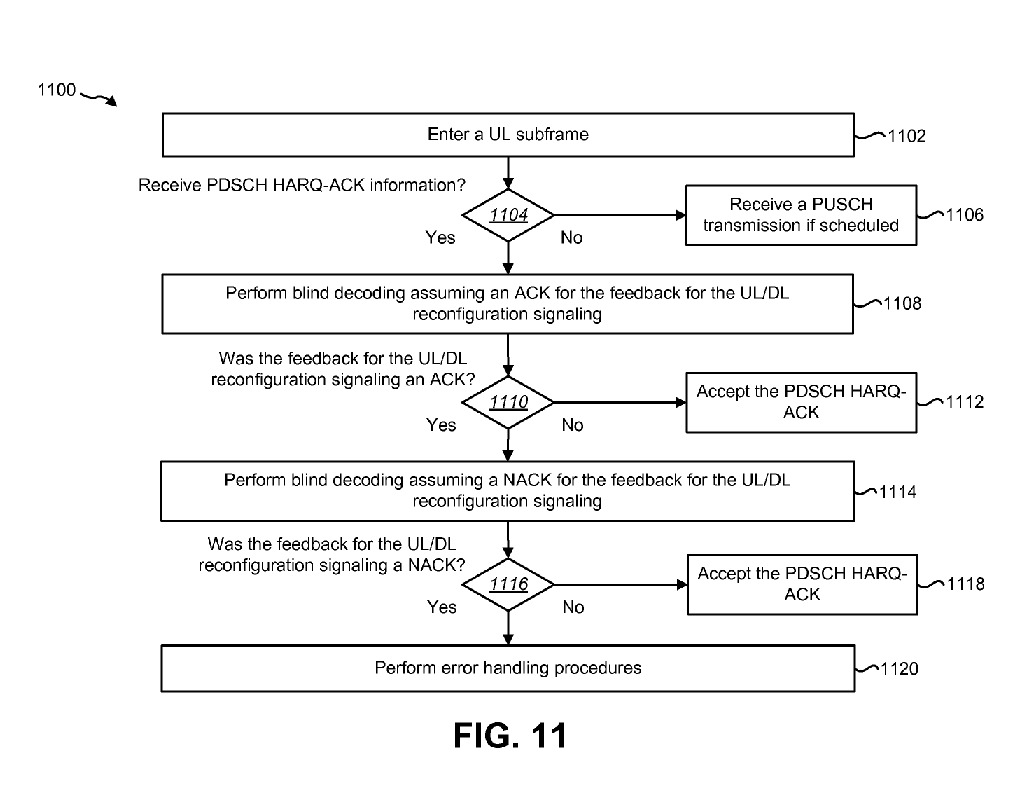

FIG. 11 is a flow diagram illustrating another implementation of a method 1100 for reconfiguration signaling by an eNB 160. In particular, FIG. 11 illustrates receiving feedback for UL/DL reconfiguration signaling.

The eNB 160 may enter 1102 a UL subframe. The eNB 160 may determine 1104 whether to receive PDSCH HARQ-ACK information in the UL subframe. For example, the UL subframe may be designated (according to a UL/DL configuration) for transmission of uplink control information (UCI) on a PUCCH and/or PUSCH. Therefore, the eNB 160 may determine 1104 whether to receive PDSCH HARQ-ACK information based on the PDSCH HARQ-ACK associations 545 of a UL/DL configuration. If the eNB 160 determines 1104 that PDSCH HARQ-ACK information is not expected to be received, then the UE 102 may receive 1106 a scheduled PUSCH transmission (e.g., if there is a UL grant associated with the UL subframe).

If the eNB 160 determines 1104 that a PDSCH HARQ-ACK is expected from a UE 102 in the UL subframe, then the eNB 160 may perform 1108 blind decoding assuming an ACK for the feedback of the UL/DL reconfiguration signaling. As discussed above in connection with FIG. 10, the PDSCH HARQ-ACK transmission may include an added ACK/NACK bit that can be used to validate the blind decoding results. Therefore, the eNB 160 may assume that the UL/DL reconfiguration signaling was correctly received. The eNB 160 may attempt to decode the feedback for the UL/DL reconfiguration signaling and the PDSCH HARQ-ACK information. In this case, the number of DL subframes reported in the PDSCH HARQ-ACK is based on the actual UL/DL configurations in the radio frames 435 across the DL association set.

The eNB 160 may determine 1110 whether the feedback for the UL/DL reconfiguration signaling was an ACK. If the results of the blind decoding indicate that the feedback for the UL/DL reconfiguration signaling was an ACK, then the eNB 160 may accept 1112 the PDSCH HARQ-ACK information. It should be noted that in the case of an ACK, the PDSCH HARQ-ACK information is based on the actual UL/DL configurations indicated by the UL/DL reconfiguration signaling.

If the eNB 160 determines 1110 that the feedback for the UL/DL reconfiguration signaling was a NACK, then the eNB 160 may perform 1114 blind decoding assuming a NACK for the feedback for the UL/DL reconfiguration signaling. Therefore, the eNB 160 may assume that the UL/DL reconfiguration signaling was not correctly received. The eNB 160 may attempt to decode the feedback for the UL/DL reconfiguration signaling and the PDSCH HARQ-ACK information. In this case, the number of DL subframes reported in the PDSCH HARQ-ACK is based on the number of subframes in the DL association set according to the DL-reference UL/DL configuration.

The eNB 160 may determine 1116 whether the feedback for the UL/DL reconfiguration signaling was a NACK. If the results of the blind decoding indicate that the feedback for the UL/DL reconfiguration signaling was a NACK, then the eNB 160 may accept 1118 the PDSCH HARQ-ACK information. It should be noted that in the case of a NACK, the PDSCH HARQ-ACK information is based on the all of the subframes in the DL association set of to the DL-reference UL/DL configuration.

If the eNB 160 determines 1116 that the feedback for the UL/DL reconfiguration signaling was not a NACK, then the eNB 160 may perform 1120 error handling procedures. In one implementation, the eNB 160 may perform error detection or decoding. The eNB 160 may drop the PDSCH HARQ-ACK. Furthermore, the eNB 160 may treat all bits in the PDSCH HARQ-ACK transmission as DTX or NACK.

It should be noted that the feedback for the UL/DL reconfiguration signaling (e.g., the added ACK/NACK bits for the UL/DL reconfiguration signaling) may provide the following benefits. The eNB 160 may be notified about whether the UL/DL reconfiguration signaling was received correctly or not. The number of PDSCH HARQ-ACK bits to be reported in a PUCCH or PUSCH transmission may be reduced. The feedback for the UL/DL reconfiguration signaling may also provide validation of the PDSCH HARQ-ACK decoding results by extra testing.

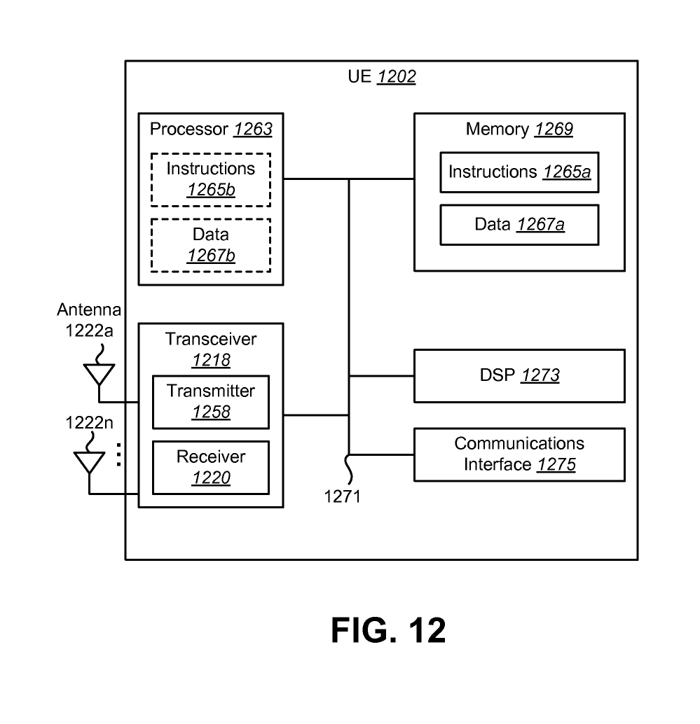

FIG. 12 illustrates various components that may be utilized in a UE 1202. The UE 1202 described in connection with FIG. 12 may be implemented in accordance with the UE 102 described in connection with FIG. 1. The UE 1202 includes a processor 1263 that controls operation of the UE 1202. The processor 1263 may also be referred to as a central processing unit (CPU). Memory 1269, which may include read-only memory (ROM), random access memory (RAM), a combination of the two or any type of device that may store information, provides instructions 1265a and data 1267a to the processor 1263. A portion of the memory 1269 may also include non-volatile random access memory (NVRAM). Instructions 1265b and data 1267b may also reside in the processor 1263. Instructions 1265b and/or data 1267b loaded into the processor 1263 may also include instructions 1265a and/or data 1267a from memory 1269 that were loaded for execution or processing by the processor 1263. The instructions 1265b may be executed by the processor 1263 to implement one or more of the methods 200, 700 and 1000 described above.

The UE 1202 may also include a housing that contains one or more transmitters 1258 and one or more receivers 1220 to allow transmission and reception of data. The transmitter(s) 1258 and receiver(s) 1220 may be combined into one or more transceivers 1218. One or more antennas 1222a-n are attached to the housing and electrically coupled to the transceiver 1218.

The various components of the UE 1202 are coupled together by a bus system 1271, which may include a power bus, a control signal bus and a status signal bus, in addition to a data bus. However, for the sake of clarity, the various buses are illustrated in FIG. 12 as the bus system 1271. The UE 1202 may also include a digital signal processor (DSP) 1273 for use in processing signals. The UE 1202 may also include a communications interface 1275 that provides user access to the functions of the UE 1202. The UE 1202 illustrated in FIG. 12 is a functional block diagram rather than a listing of specific components.

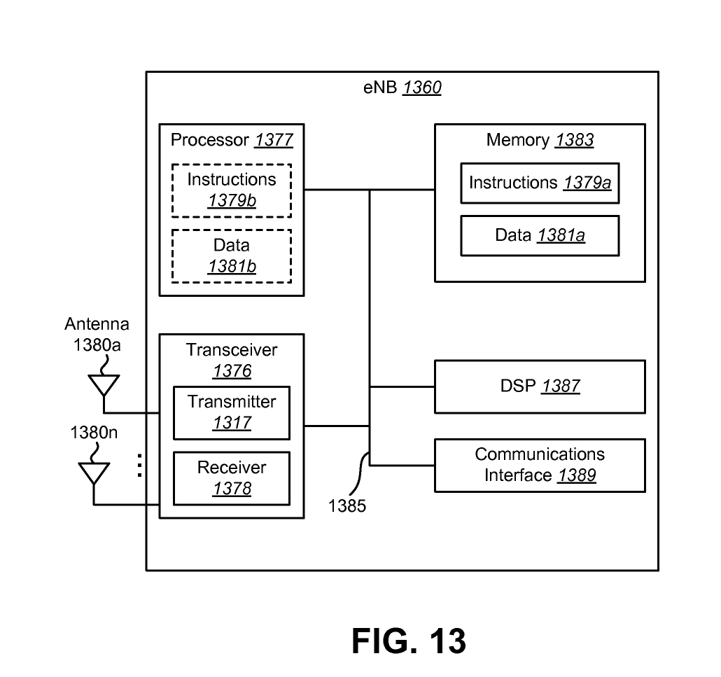

FIG. 13 illustrates various components that may be utilized in an eNB 1360. The eNB 1360 described in connection with FIG. 13 may be implemented in accordance with the eNB 160 described in connection with FIG. 1. The eNB 1360 includes a processor 1377 that controls operation of the eNB 1360. The processor 1377 may also be referred to as a central processing unit (CPU). Memory 1383, which may include read-only memory (ROM), random access memory (RAM), a combination of the two or any type of device that may store information, provides instructions 1379a and data 1381a to the processor 1377. A portion of the memory 1383 may also include non-volatile random access memory (NVRAM). Instructions 1379b and data 1381b may also reside in the processor 1377. Instructions 1379b and/or data 1381b loaded into the processor 1377 may also include instructions 1379a and/or data 1381a from memory 1383 that were loaded for execution or processing by the processor 1377. The instructions 1379b may be executed by the processor 1377 to implement one or more of the methods 300 and 1100 described above.

The eNB 1360 may also include a housing that contains one or more transmitters 1317 and one or more receivers 1378 to allow transmission and reception of data. The transmitter(s) 1317 and receiver(s) 1378 may be combined into one or more transceivers 1376. One or more antennas 1380a-n are attached to the housing and electrically coupled to the transceiver 1376.

The various components of the eNB 1360 are coupled together by a bus system 1385, which may include a power bus, a control signal bus and a status signal bus, in addition to a data bus. However, for the sake of clarity, the various buses are illustrated in FIG. 13 as the bus system 1385. The eNB 1360 may also include a digital signal processor (DSP) 1387 for use in processing signals. The eNB 1360 may also include a communications interface 1389 that provides user access to the functions of the eNB 1360. The eNB 1360 illustrated in FIG. 13 is a functional block diagram rather than a listing of specific components.

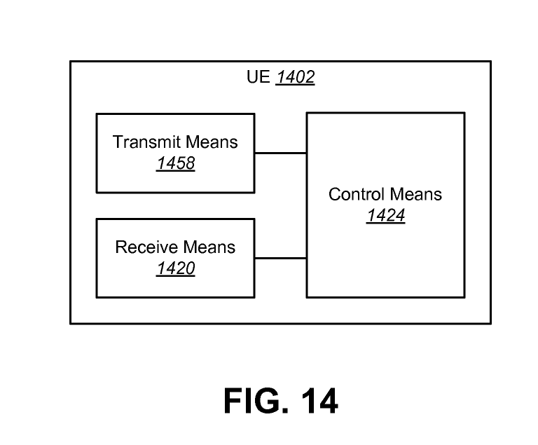

FIG. 14 is a block diagram illustrating one configuration of a UE 1402 in which systems and methods for reconfiguration signaling may be implemented. The UE 1402 includes transmit means 1458, receive means 1420 and control means 1424. The transmit means 1458, receive means 1420 and control means 1424 may be configured to perform one or more of the functions described in connection with FIG. 2, FIG. 7, FIG. 10 and FIG. 12 above. FIG. 12 above illustrates one example of a concrete apparatus structure of FIG. 14. Other various structures may be implemented to realize one or more of the functions of FIG. 2, FIG. 7, FIG. 10 and FIG. 12. For example, a DSP may be realized by software.

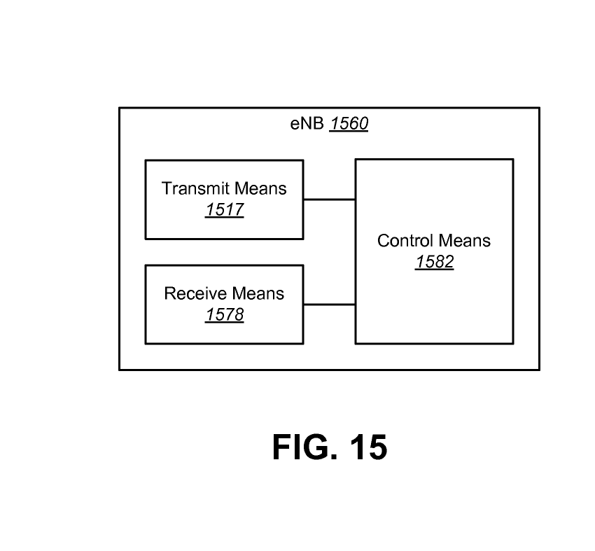

FIG. 15 is a block diagram illustrating one configuration of an eNB 1560 in which systems and methods for reconfiguration signaling may be implemented. The eNB 1560 includes transmit means 1517, receive means 1578 and control means 1582. The transmit means 1517, receive means 1578 and control means 1582 may be configured to perform one or more of the functions described in connection with FIG. 3, FIG. 11 and FIG. 13 above. FIG. 13 above illustrates one example of a concrete apparatus structure of FIG. 15. Other various structures may be implemented to realize one or more of the functions of FIG. 3, FIG. 11 and FIG. 13. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, Electrically Erasable Programmable Read-Only Memory (EEPROM), Compact Disc Read-Only Memory (CD-ROM) or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A user equipment (UE) for receiving time-division duplexing (TDD) uplink/downlink (UL/DL) configurations, comprising:
a processor; and
memory in electronic communication with the processor, wherein instructions stored in the memory are executable to:
decode UL/DL reconfiguration signaling on a physical downlink control channel (PDCCH) or enhanced physical downlink control channel (EPDCCH);
determine if the UL/DL reconfiguration signaling is correctly decoded; and
send feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

2. The UE of claim 1, wherein the feedback for the UL/DL reconfiguration signaling is determined based on the uplink subframe.

3. The UE of claim 1, wherein the feedback for the UL/DL reconfiguration signaling comprises an acknowledgement or negative acknowledgement (ACK/NACK) message.

4. The UE of claim 3, wherein if an ACK is generated for the UL/DL reconfiguration signaling, the instructions are further executable to generate the PDSCH HARQ-ACK information based on a DL subframe or a special subframe in a DL association set of a DL-reference UL/DL configuration, wherein the DL subframe or the special subframe is determined based on the UL/DL reconfiguration signaling.

5. The UE of claim 3, wherein if a NACK is generated for the UL/DL reconfiguration signaling, the instructions are further executable to generate the PDSCH HARQ-ACK information based on a DL subframe or a special subframe in a DL association set of a DL-reference UL/DL configuration, wherein the DL subframe or the special subframe is determined based on the DL-reference UL/DL configuration.

6. The UE of claim 3, wherein if a NACK is generated for the UL/DL reconfiguration signaling, the instructions are further executable to generate the PDSCH HARQ-ACK information based on a DL subframe or a special subframe in a DL association set of a DL-reference UL/DL configuration, wherein the DL subframe or the special subframe is determined based on a UL/DL configuration determined by a SystemInformationBlock1 signal or a RadioResourceConfigCommon signal.

7. The UE of claim 3, wherein if a NACK is generated for the UL/DL reconfiguration signaling, the instructions are further executable to generate the PDSCH HARQ-ACK information based on a DL subframe or a special subframe in a DL association set of a DL-reference UL/DL configuration, wherein the DL subframe is a fixed DL subframe and the special subframe is a fixed special subframe.

8. The UE of claim 3, wherein if the UL/DL reconfiguration signaling is correctly decoded, the instructions are further executable to determine a DL subframe or a special subframe based on a UL/DL configuration indicated by the UL/DL reconfiguration signaling.

9. The UE of claim 3, wherein if the UL/DL reconfiguration signaling is not correctly decoded, the instructions are further executable to determine a DL subframe based on a fixed DL subframe or a special subframe based on a fixed special subframe.

10. The UE of claim 3, wherein if the UL/DL reconfiguration signaling is not correctly decoded, the instructions are further executable to determine a DL subframe or a special subframe based on a UL/DL configuration determined by a SystemInformationBlock1 signal or a RadioResourceConfigCommon signal.

11. The UE of claim 3, wherein if the UL/DL reconfiguration signaling is not correctly decoded, the instructions are further executable to determine a DL subframe or a special subframe based on a PDCCH downlink control information (DCI) format.

12. The UE of claim 1, wherein the UL/DL reconfiguration signaling is a PDCCH or an enhanced physical downlink control channel (EPDCCH) with a given DCI format.

13. An evolved Node B (eNB) for sending time-division duplexing (TDD) uplink/downlink (UL/DL) configurations, comprising:
a processor; and
memory in electronic communication with the processor, wherein instructions stored in the memory are executable to:
send UL/DL reconfiguration signaling on a physical downlink control channel (PDCCH); and
receive feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

14. The eNB of claim 13, wherein the instructions are further executable to receive the feedback for the UL/DL reconfiguration signaling and the PDSCH HARQ-ACK information if the PDSCH HARQ-ACK information is expected in the uplink subframe.

15. The eNB of claim 13, wherein the feedback for the UL/DL reconfiguration signaling comprises an acknowledgement or negative acknowledgement (ACK/NACK) message.

16. The eNB of claim 15, wherein the instructions are further executable to decode the feedback for the UL/DL reconfiguration signaling and the PDSCH HARQ-ACK information assuming an ACK for the UL/DL reconfiguration signaling, wherein the decoding is based on a DL subframe or a special subframe in a DL association set of a DL-reference UL/DL configuration, and wherein the DL subframe or the special subframe is determined based on the UL/DL reconfiguration signaling.

17. The eNB of claim 15, wherein the instructions are further executable to decode the feedback for the UL/DL reconfiguration signaling and the PDSCH HARQ-ACK information assuming a NACK for the UL/DL reconfiguration signaling, wherein the decoding is based on a DL subframe or a special subframe in a DL association set of a DL-reference UL/DL configuration, and wherein the DL subframe or the special subframe is determined based on the DL-reference UL/DL configuration.

18. The eNB of claim 13, wherein the instructions are further executable to:
determine the correctness of the feedback for the UL/DL reconfiguration signaling based on a decoded output; and
determine the validity of the PDSCH HARQ-ACK information based on the decoded output.

19. The eNB of claim 13, wherein the UL/DL reconfiguration signaling is a PDCCH or an enhanced physical downlink control channel (EPDCCH) with a given DCI format.

20. A method for receiving time-division duplexing (TDD) uplink/downlink (UL/DL) configurations by a user equipment (UE), comprising:
decoding UL/DL reconfiguration signaling on a physical downlink control channel (PDCCH) or enhanced physical downlink control channel (EPDCCH);
determining if the UL/DL reconfiguration signaling is correctly decoded; and
sending feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

21. The method of claim 20, wherein the feedback for the UL/DL reconfiguration signaling comprises an acknowledgement or negative acknowledgement (ACK/NACK) message.

22. The method of claim 20, wherein if the UL/DL reconfiguration signaling is correctly decoded, the method further comprises determining a DL subframe or a special subframe based on a UL/DL configuration indicated by the UL/DL reconfiguration signaling.

23. The method of claim 20, wherein if the UL/DL reconfiguration signaling is not correctly decoded, the method further comprises determining a DL subframe based on a fixed DL subframe or a special subframe based on a fixed special subframe.

24. The method of claim 20, wherein if the UL/DL reconfiguration signaling is not correctly decoded, the method further comprises determining a DL subframe or a special subframe based on a UL/DL configuration determined by a SystemInformationBlock1 signal or a RadioResourceConfigCommon signal.

25. The method of claim 20, wherein if the UL/DL reconfiguration signaling is not correctly decoded, the method further comprises determining a DL subframe or a special subframe based on a PDCCH downlink control information (DCI) format.

26. A method for sending time-division duplexing (TDD) uplink/downlink (UL/DL) configurations by an evolved Node B (eNB), comprising:
sending UL/DL reconfiguration signaling on a physical downlink control channel (PDCCH); and
receiving feedback for the UL/DL reconfiguration signaling and physical downlink shared channel (PDSCH) hybrid automatic repeat request acknowledgement/negative acknowledgement (HARQ-ACK) information in an uplink subframe corresponding to the PDSCH HARQ-ACK information.

27. The method of claim 26, further comprising receiving the feedback for the UL/DL reconfiguration signaling and the PDSCH HARQ-ACK information if the PDSCH HARQ-ACK information is expected in the uplink subframe.

28. The method of claim 26, wherein the feedback for the UL/DL reconfiguration signaling comprises an acknowledgement or negative acknowledgement (ACK/NACK) message.

29. The method of claim 28, further comprising decoding the feedback for the UL/DL reconfiguration signaling and the PDSCH HARQ-ACK information assuming an ACK for the UL/DL reconfiguration signaling, wherein the decoding is based on a DL subframe or a special subframe in a DL association set of a DL-reference UL/DL configuration, and wherein the DL subframe or the special subframe is determined based on the UL/DL reconfiguration signaling.

30. The method of claim 28, further comprising decoding the feedback for the UL/DL reconfiguration signaling and the PDSCH HARQ-ACK information assuming a NACK for the UL/DL reconfiguration signaling, wherein the decoding is based on a DL subframe or a special subframe in a DL association set of a DL-reference UL/DL configuration, and wherein the DL subframe or the special subframe is determined based on the DL-reference UL/DL configuration.
